(19) United States
(12) Patent Application Publication
(10) Pub. No.: US 2014/0104442 A1
(43) Pub. Date: Apr. 17, 2014

(54) IMAGE INFORMATION PROCESSING SYSTEM

(71) Applicant: Ripplex Inc., Tokyo (JP)

(72) Inventor: Norihiko NAONO, Tokyo (JP)

(73) Assignee: Ripplex Inc., Tokyo (JP)

(21) Appl. No.: 14/105,541

(22) Filed: Dec. 13, 2013

Related U.S. Application Data
(63) Continuation of application No. PCT/JP2011/063726, filed on Jun. 15, 2011.

(51) Int. Cl. H04N 1/00

(52) U.S. Cl. CPC H04N 1/00127
USPC 348/207.1

(57) ABSTRACT

Provided is as one embodiment an imaging terminal characterized by: receiving, from a first memory card, first memory card ID information identifying the first memory card; performing a calculation of the first memory card ID information; transmitting, to the first memory card, a calculation result of the first memory card ID information as second memory card ID information uniquely identifying the first memory card within a network connecting an information terminal with the first memory card connected; receiving, from a second memory card, third memory card ID information identifying the second memory card; performing the calculation of the third memory card ID information; and transmitting, to the second memory card, a calculation result of the third memory card ID information as fourth memory card ID information uniquely identifying the second memory card within the network in which communication is performed via the information terminal with the second memory card connected.

### CROSS REFERENCE TO RELATED APPLICATIONS

This application is a U.S. continuation application filed under 35 U.S.C. §111 (a), of International application No. PCT/JP2011/063726, filed on May 15, 2011, the disclosure of which are incorporated by reference.

### BACKGROUND

1. Technical Field

The present invention is related to an information terminal, a memory card, an imaging terminal, a display terminal, a server and a system arranged with these components, each of which is for managing images.

2. Description of Related Art

With the spread of digital cameras, the number of images taken by one user has increased dramatically compared with the period when silver halide film type cameras were mainstream. The reason for this is that the cost per photographed image is low. Furthermore, in recent years, with the miniaturization of semiconductor technology, the storage capacity of storage devices such as a flash memory used in digital cameras has increased which has led to an increase in the number of images taken. A camera user can now take a large amount of images without having to worry about the limits of storage capacity and cost, and by post-organization of the images, the user can select only high-quality images and discard the rest.

In addition, the type of imaging terminal used by a user is also diversified. One user often selectively uses a plurality of imaging terminals such as a single-lens reflex type camera to take high-resolution still images, a compact type camera which can be carried around at all times, and a video camera to take the video. In recent years, mobile information terminals other than cameras, for example, portable personal computers, cellular phones, and mobile music players have also been adapted to be mounted with the imaging devices. These mobile type information terminals are also being used as imaging devices. As described above, a situation in which one user carries a plurality imaging devices and takes a large number of images using each terminal has arisen.

Most of the image information taken by imaging devices is stored in a memory card connected to the imaging device. An SD memory card, a CompactFlash (registered trademark), and a USB memory are used as the memory cards. As a result, in the case where one user has a plurality of information terminals, that user has a plurality of memory cards and the image information taken using the plurality of terminals is stored in a among the plurality of memory cards. Furthermore, in recent years, because the part price per capacity has dropped, when the volume of the image information reaches the storage capacity of the memory card connected to the imaging terminal, a new memory card must be connected to the imaging device and the old memory card is retained in order to keep the image information.

### SUMMARY

As described above, the situation where one user uses a plurality of imaging terminals, takes a large amount of image information using each imaging terminal, stores the image information is across a plurality of memory cards, and further stores the memory cards is becoming common. Consequently, it is difficult for the user to maintain and manage the large amount of image information.

As a method for managing and maintaining a large amount of image information taken by a plurality of imaging terminals and stored in a plurality of memory cards, it is often the case that all or part of the image information is managed by copying to an information terminal such as a personal computer. However, in reality, because there is a limit to the capacity of the storage means in the information terminal it is not easy to store and manage all of the image information in the information terminal. In the case where the information terminal is connected to the Internet, a method exists to use a storage service via a network and copy the image information to an external server. However, by copying the image information to an information terminal or storage service from a memory card in this manner, the same image information is distributed across memory cards, information terminal, and servers of a storage service and it becomes more difficult to manage the image information.

Maintenance and management of a large amount of image information taken by a plurality of imaging terminals and stored in a plurality of memory cards, information terminals, or storage service over a network has the following five points which need to be solved.

The first point is that it is complicated to copy image information to an information terminal which performs maintenance and management of the image information from an imaging device. After a user takes an image, removes a memory card from the imaging terminal, and connects to an information terminal to perform maintenance and management of the images, the user copies this image information to the information terminal. A personal computer is often used as an information terminal that performs maintenance and management of images. For general users, an operation of copying a large amount of image information to a personal computer from a memory card is complicated.

The second point is that specifying a storage location for the photographed images is difficult. It is difficult for a user find a specific image previously taken which is stored in a particular memory card in a state in which the images taken with a plurality of imaging terminals is stored in a plurality of memory cards. Furthermore, in the case where a part of the image information stored in the memory card is copied to an information terminal such as a personal computer or storage service via the Internet, it is difficult to specify which image is stored in which storage location. Despite a large amount of image information taken by a user being stored across a plurality of memory cards, information terminals, and servers of a storage service, this problem occurs because there is no method which manages the image information in a unified manner.

The third point is that a backup is difficult. In addition to a user taking a large amount of images using a plurality of imaging terminals, in recent years the amount of information per image has increased with improved performance of imaging elements. In particular, the amount of image information of a video is large. The total capacity of image information taken by a single user has increased significantly due to the synergistic effects of these. The total capacity of all images taken by a single user often exceeds a storage device such as a memory card or personal computer. As a result, in the case where the image information is backed up, the image information must be distributed across a plurality of memory cards, information terminals, and servers of storage services. However, this has made maintaining and managing image information even more difficult.

The fourth point is that it is difficult to browse image information on a plurality of display terminals and send the image information to other people. For example, in the case where a mobile phone is used as an imaging device, it is easy to send image information by email to other people, upload to a storage service via a network, or browse on a personal computer. However, for example, images to be sent to others or to be browsed on a different display terminal are sometimes taken with a single-lens reflex camera which does not include a network function, and stored in the card. In this case, in order to send images to other people or browse using another display terminal via a network, a user must first remove a memory card from the imaging device, connect it to an information terminal such as a personal computer, copy the image information, and send the images via the network.

In order to omit these operations, directly connecting a camera or a memory card to the Internet has been proposed (see Japanese Patent No. 4251757, Japanese Patent No. 3664203, and Japanese Patent Laid Open No. 2003-283900, for example). Furthermore, a proposal for either storing image information in a memory card of an imaging terminal or selecting or setting a direct upload to a server on a network is disclosed (see Japanese Patent Laid Open No. 2010-178360, for example). However, although the operations required to copy using this method are reduced, the method does not contribute to solving the first to third problems described above. In fact, in some cases unified maintenance and management of all taken images by easily copying image information becomes more difficult.

The fifth point is that because image information is stored across memory cards or information terminals, it is difficult to handle image information taken using a plurality of imaging terminals via the Web. For example, because storage capacity in a mobile phone terminal is small, a user does not copy image information the user has taken on a device other than the mobile phone terminal to a mobile phone terminal but must request that they wish to browse via a Web browser. However, in a conventional method, because there is no method to manage which image information is stored in a particular memory card regardless of the ability to access the memory card on which the image information is stored via the internet, it is difficult for the user to handle images taken in a unified manner via the Web.

In order to solve these types of problems, a proposal is disclosed in which image information distributed over a plurality of storage locations taken by a single user using a plurality of cameras is treated by a server in a unified manner between information terminals or a plurality of Web services by managing a correlation between image information taken by a camera and summary image information having a smaller amount of information (refer to Japanese Patent No. 4717963, for example). However, in actuality, most of the image information taken using a camera is first stored in a memory card and then stored unaltered. In a conventional method, since there was no method for uniquely specifying each memory card on the internet, a memory card, an information terminal, and a server could not be treated in a unified manner as storage locations of image information.

The present invention has been invented in view of the circumstances described above by providing an information terminal which users can use even to maintain and manage image information that is stored in a memory card, an information terminal, or a server in a unified manner, a memory card, an imaging terminal, a display terminal, a mobile terminal, a server, a system and a method by using a card ID that uniquely identifies a memory card and a camera ID that uniquely identifies an imaging terminal on the Internet.

As one embodiment of the present invention, a memory card is provided. The memory card is configured to execute steps of: sending first memory card identification information from a first memory card identification storage part for the storing the first memory card identification information to a first imaging terminal; receiving a first calculation result of a calculation performed on the first memory card identification information by the first imaging terminal from the first imaging terminal; storing the first calculation result as second memory card identification information into a second memory card identification information storage part; receiving first image information taken by the first imaging terminal and first image identification information for specifying the first image information from the first imaging terminal; sending the second memory card identification information and the first image identification information, in a state where the second memory card identification information and the first image identification information are correlated, to an information terminal; sending the first memory card identification information to a second imaging terminal; receiving a second calculation result of a calculation performed on the first memory card identification information by the second imaging terminal from the second imaging terminal; storing the second calculation result as third memory card identification information into the second memory card identification information storage part; receiving second image information and second image identification information for specifying the second image information from the second imaging terminal; and

sending the third memory card identification information and the second image identification information, in a state where the third memory card identification information and the second image identification information are correlated, to the information terminal.

As one embodiment of the present invention, an imaging terminal is provided. The imaging terminal is configured to execute steps of: receiving first memory card identification information for identifying a first memory card from the first memory card; sending a result of performing a calculation on the first memory card identification information as second memory card identification information, which can uniquely identify the first memory card within a network communicating via an information terminal connected with the first memory card, to the first memory card; receiving third memory card identification information for identifying a second memory card from the second memory card; and sending the result of performing a calculation on the third memory card identification information as fourth memory card identification information which can uniquely identify the second memory card, within the network communicating via the information terminal connected with the second memory card, to the second memory card.

As one embodiment of the present invention, an information terminal is provided. The information terminal includes display means for displaying an image information display part. The information terminal is configured to execute steps of: receiving a result of performing a calculation on first memory card identification information by an imaging terminal as second memory card identification information, which can uniquely specify a first memory card within a network connected to the information terminal, the first memory card identification information being stored in a first memory card identification information storage part of the first memory card; receiving first image information taken by the imaging terminal and first image identification information for identifying the first image information from the first memory card; correlating and storing the second memory card identification information with the first image information and the first image identification information; receiving a result of performing a calculation on third memory card identification information by the imaging terminal as fourth memory card identification information, which can uniquely specify a second memory card within a network connected to the information terminal, the third memory card identification information being stored in a second memory card identification information storage part of the second memory card; receiving second image information taken by the imaging terminal and second image identification information for identifying the second image information from the second memory card; and correlating and storing the fourth memory card identification information with the second image information and the second image identification information.

As one embodiment of the present invention, an information terminal is provided. The information terminal includes display means for displaying an image information display part. The information terminal is configured to execute steps of: receiving, from a first memory card, a result of performing a calculation on first memory card identification information by an imaging terminal as second memory card identification information, which can identify the first memory card, the first memory card identification card identification information being stored in a first memory card identification information storage part of the first memory card; receiving, from the first memory cared, first image information taken by the imaging terminal and first image identification information for identifying the first image information; correlating and storing the second memory card identification information with the first image information and the first image identification information; receiving, from a second memory cared, a result of calculating third memory card identification information by the imaging terminal as fourth memory card identification information for identifying the second memory card, the third memory card identification information being stored in the second memory card identification information storage part of a second memory card; receiving, from the second memory card, second image information taken by the imaging terminal and second image identification information for identifying the second image information from the second memory card; and correlating and storing the fourth memory card identification information with the second image information and the second image identification information.

As one embodiment of the present invention, a system is provided. The system is configured to execute steps of: storing first memory card identification information into a first memory card identification information storage part of a first memory card; sending from the first memory cared to an imaging terminal the first memory card identification information which cannot be read by an information terminal; generating second memory card identification information as a result of performing a calculation on the first memory card identification information at the imaging terminal; sending from the imaging terminal to the first memory card the second memory card identification information; storing from the imaging terminal to the first memory card the second memory card identification information into a second identification information storage part in the first memory card; sending first image information taken by the imaging terminal, first summary image information generated from the first image information, and first image identification information for identifying the first image information; correlating and storing the first image information, the first summary image information and the first image identification information into the first memory card; storing third memory card identification information into a third memory card identification information storage part of a second memory card; sending from the information terminal to the imaging terminal the third memory card identification information which cannot be read by the information terminal; generating fourth memory card identification information as a result of performing a calculation on the third memory card identification information at the imaging terminal; sending from the imaging terminal to the second memory card the fourth identification information; storing the fourth identification information into a fourth identification information storage part by the second memory card; sending from the imaging terminal to the second memory card second image information taken by the imaging terminal, second summary image information generated from the second image information, and second image identification information for identifying the second image information; correlating and storing the second image information, the second summary image information, and the second image identification information into the second memory card; sending from the first memory card the second memory card identification information, the first image information, the first summary image information, and the first image identification information, the second memory card identification information, the first image information, the first summary image information, and the first image identification information being correlated; correlating and storing the second memory card identification information, the first image information, the first summary image information, and the first image identification information into the information terminal; sending from the second memory card the fourth memory card identification information, the second image information, the second summary image information, and the second image identification information, the fourth memory card identification information, the second image information, the second summary image information, and the second image identification information being correlated; and correlating and storing the fourth memory card identification information, the second image information, the second summary image information, and the second image identification information into the information terminal.

As one embodiment of the present invention, a system is provided. The system is configured to execute steps of: sending, from a memory card to a first imaging terminal, first memory card identification information in a first memory card identification information storage part, the first memory card identification information being unable to be read from an information terminal; generating second memory card identification information which is a result of performing a calculation on the first memory card identification information at the first imaging terminal; sending from the first imaging terminal to the memory card the second memory card identification information; storing the second memory card identification information into a second identification information storage part into the memory card; sending from the first imaging terminal to the memory card first image information taken by the first imaging terminal, first summary image information generated from the first image information, and first image identification information for identifying the first image information; correlating and storing the first image information, the first summary image information, and the first image identification information into the memory card; sending the first memory card identification information to a second imaging terminal; generating third memory card identification information which is a result of performing a calculation on the first memory card identification information at the second imaging terminal; sending from the second imaging terminal to the memory card the third memory card identification information; storing the third memory card identification information into the second memory card identification information storage part of the memory card; sending from the second imaging terminal to the memory card second image information taken by the second imaging terminal, second summary image information generated from the second image information, and second image identification information for identifying the second image information; correlating and storing the second image information, the second summary image information, and the second image identification information into the memory card; sending from the memory card to the information terminal the first summary image information, the first image identification information, and the second memory card identification information, the first summary image information, the first image identification information, and the second memory card identification information being correlated; sending from the memory card to the information terminal the second summary image information, the second image identification information, and the third memory card identification information, the second summary image information, the second image identification information, and the third memory card identification information being correlated; and correlating and storing the first summary image information, the first image identification information, and the second memory card identification information, and correlating the second summary image information, the second image identification information and the third memory card identification information respectively into the information terminal.

### BRIEF EXPLANATION OF THE DRAWINGS

FIG. 1 is a schematic structural diagram of an image processing system related to an embodiment of the present invention;

FIG. 2 is a schematic structural diagram of an information terminal related to an embodiment of the present invention;

FIG. 3 is a schematic structural diagram of a server related to an embodiment of the present invention;

FIG. 4 is a schematic structural diagram of a memory card related to an embodiment of the present invention;

FIG. 5 is a schematic structural diagram of an imaging terminal related to an embodiment of the present invention;

FIG. 6 is a schematic structural diagram of an information terminal related to an embodiment of the present invention;

FIG. 7 is a schematic structural diagram of a server related to an embodiment of the present invention;

FIG. 8 is a schematic structural diagram of a mobile terminal related to an embodiment of the present invention;

FIG. 9 is a schematic structural diagram of a server related to an embodiment of the present invention;

FIG. 10 is a flowchart of processes related to an embodiment of the present invention;

FIG. 11 is a diagram of one example of information stored in a memory card related to an embodiment of the present invention;

FIG. 12 is a diagram of one example of information stored in a memory card related to an embodiment of the present invention;

FIG. 13 is a diagram of one example of information stored in an image information table related to an embodiment of the present invention;

FIG. 14 is a diagram of one example of information stored in an image attribute table related to an embodiment of the present invention;

FIG. 15 is a diagram of one example of information stored in a card additional information table related to an embodiment of the present invention;

FIG. 16 is a diagram of one example of a summary image list display screen related to an embodiment of the present invention;

FIG. 17 is a diagram of one example of an image displayed by a display means related to an embodiment of the present invention;

FIG. 18 is a diagram of one example of an image displayed by a display means related to an embodiment of the present invention;

FIG. 19 is a diagram of one example of an image displayed by a display means related to an embodiment of the present invention;

FIG. 20 is a flowchart of processes related to an embodiment of the present invention;

FIG. 21 is a diagram of one example of an authentication screen of a storage service related to an embodiment of the present invention;

FIG. 22 is a diagram of one example of information stored by an image attribute table related to an embodiment of the present invention;

FIG. 23 is a diagram of one example of information stored in an image information storage means related to an embodiment of the present invention;

FIG. 24 is a diagram of one example of an image displayed by a display means related to an embodiment of the present invention;

FIG. 25 is a diagram of one example of authentication screen related to an embodiment of the present invention;

FIG. 26 is a flowchart of processes related to an embodiment of the present invention;

FIG. 27 is a diagram of one example of a transfer destination input screen related to an embodiment of the present invention;

FIG. 28 is a diagram of one example of information stored by a card additional information table related to an embodiment of the present invention;

FIG. 29 is a diagram of one example of a memory card connection request screen related to an embodiment of the present invention;

FIG. 30 is a flowchart of processes related to an embodiment of the present invention;

FIG. 31 is a diagram of one example of a memory card connection request screen related to an embodiment of the present invention;

FIG. 32 is a diagram of one example of a card additional information table related to an embodiment of the present invention;

FIG. 33 is a diagram of one example of a card NID table of a server Y related to an embodiment of the present invention;

FIG. 34 is a diagram of one example of a summary image list screen related to an embodiment of the present invention;

FIG. 35 is a flowchart of processes related to an embodiment of the present invention; and

FIG. 36 is a diagram of one example of a summary image list screen related to an embodiment of the present invention.

### DESCRIPTION OF EMBODIMENTS

The best presently contemplated embodiments for carrying out the present invention are described below. The scope of the present invention is clearly defined by the scope of the appended claims and the explanation of the present specification should not be interpreted in a limiting sense and intends to simply exemplify the general principles of the present invention.

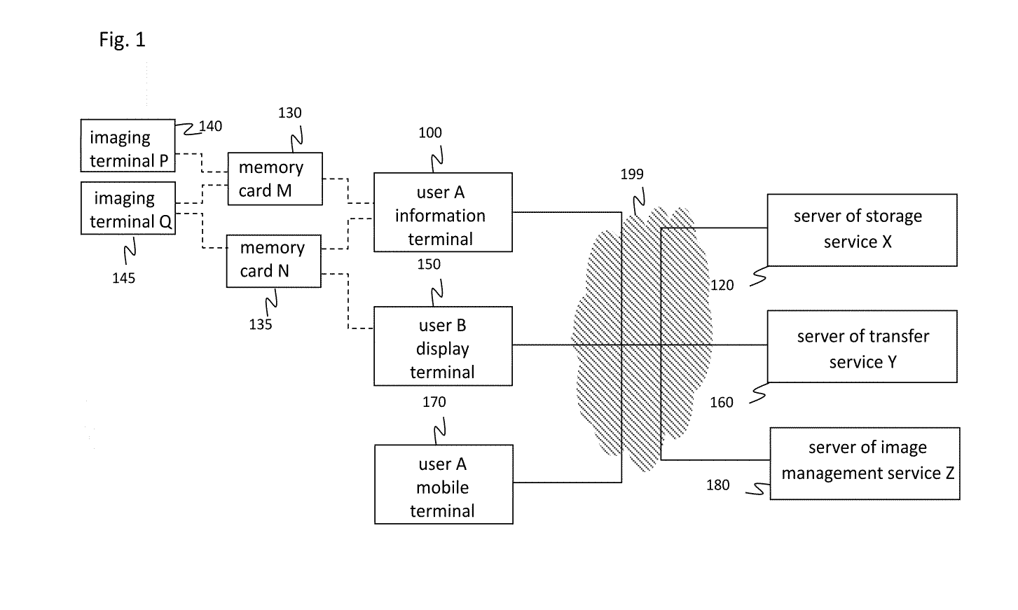

FIG. 1 is a schematic structural diagram of an image processing system and an example of an embodiment of the present invention. The image information processing system which is an example of an embodiment of the present invention is formed by an information terminal 100 of a user A, a server 120 of a storage service X, a memory card M 130, a memory card N 135, an imaging terminal P 140, an imaging terminal Q 145, a display terminal of a user B 150, a server 160 of a transfer service Y, and a server 180 of a mobile terminal 170 of the user A and an image management service Z. The information terminal 100 of the user A, the server 120 of storage service X, the display terminal 150 of the user B, a server 160 of the transfer service Y, and the server 180, the mobile terminal 170 of the user, and the image management service Z are connected via a network 199. In addition, after the user A takes images in a state in which the imaging terminal P 140 is connected to the memory card M 130, the user A connects the memory card M 130 to the information terminal 100. Similarly, after the user A takes images in a state in which the imaging terminal Q 145 is connected to the memory card M 130, the user A connects the memory card M 130 to the information terminal 100. After the memory card N 135 is connected to the information terminal 100 of the user A, the memory card N 135 is connected to the display terminal 150 of the user B. In FIG. 1, the dotted line represents that they are sometimes connected and sometimes disconnected in the operation of the embodiments of the present invention shows below. That is, a memory card can be attached to and de-attached from an information terminal and an imaging device.

Furthermore, it should be noted that in the present specification and the attached drawings, the server 120 of the storage service X may be hereinafter abbreviated to the server X, the server 160 of the transfer service Y to the server Y, and the server 180 of the image management service Z to the server Z. In addition, the information terminal 100 of the user A may be abbreviated to the information terminal A, the display terminal of the user B to the display terminal B, and the mobile terminal of the user A to the mobile terminal B. In addition, the image information in an embodiment of the present invention may be still or video images. An information terminal may be a mobile information terminal, a mobile phone terminal, a music player, a camera, or a game consoles as well as a personal computer. A display terminal may be any terminal with a display means such as a photo frame terminal, a television, a personal computer, a music player, a camera, a mobile phone terminal, a mobile information terminal, or a game console. A mobile terminal may be any mobile type information processing terminal such as a mobile phone terminal, a mobile information terminal, a music player, or a game console.

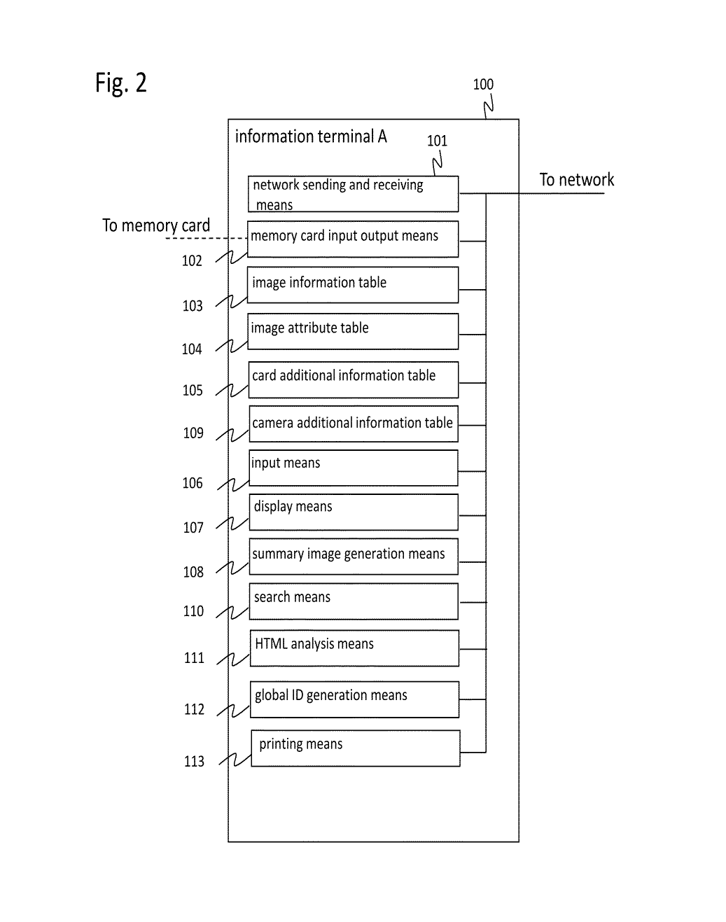

FIG. 2 is an example of a schematic structural diagram of the information terminal 100. The information terminal 100 includes a network sending and receiving means 101, a memory card input and output means 102, an image information table 103, an image attribute table 104, a card additional information table 105, a camera additional information table 109, an input means 106, a display means 107, a summary image generation means 108, a search means 110, an HTML analysis means 111, a global ID generation means 112, and a printing means 113.

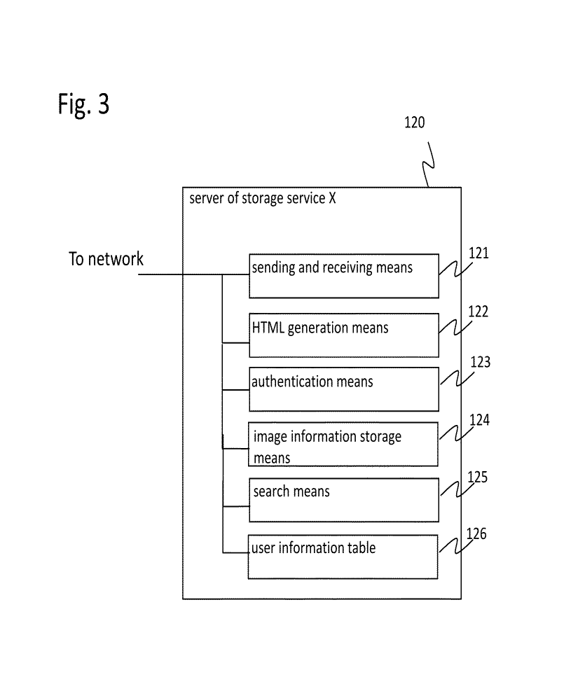

FIG. 3 is an example of a schematic structural diagram of the server X120. The server X120 includes a sending and receiving means 121, an HTML generation means 122, an authentication means 123, an image information storage means 124, a search means 125, and a user information table 126.

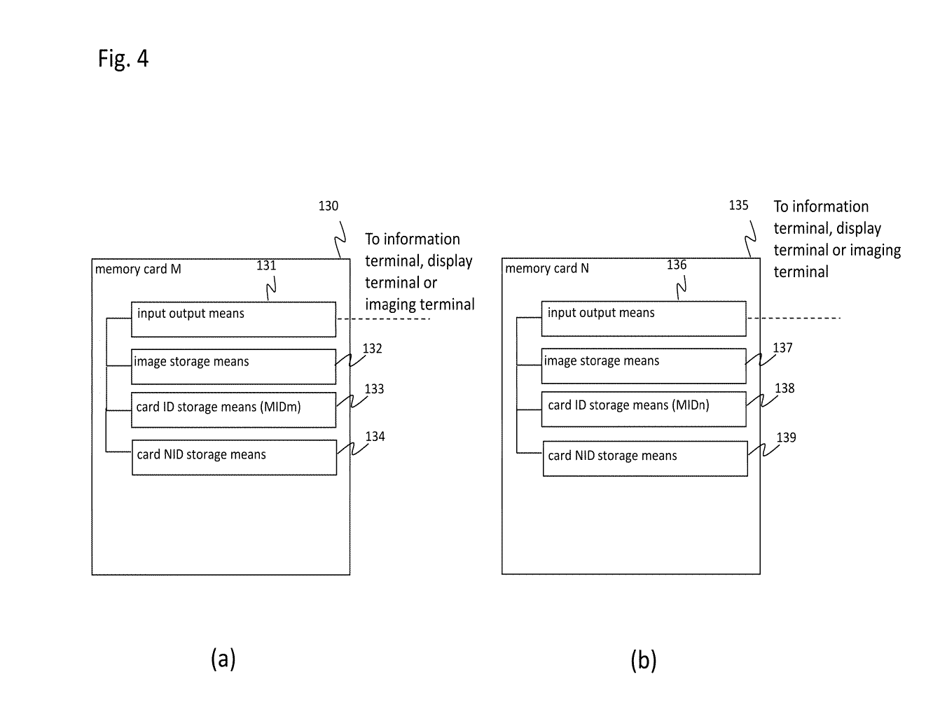

FIG. 4(a) is an example of a schematic structural diagram of the memory card M 130. Memory card M 130 includes an input and output means 131, an image storage means 132, a card ID storage means 133, and a card additional information storage means 134. In the diagrams and the explanations below, a network ID is sometimes abbreviated to a card NID. In the example shown in FIG. 4 (a), MIDm, which is the card ID of the memory card M 130, is stored in advance in the card storage means 133. In the present embodiment, it is assumed that the contents of the card ID storage means 133 cannot be read from the information terminal A. The card NID storage means 134 is a storage means for storing NIDm, which is a card NID of the memory card M 130 generated by an imaging terminal P140 or imaging terminal Q145 respectively in step S1002 or step S1004 described below. MIDm, which is the card ID of the memory card M 130, may be an ID provided in advance to the memory card M such as a code or a serial number, which represents the maker, factory or production facility, or the like of a memory card. In addition, here, a memory card M is shown as an example of having one card ID MIDm, however, the memory card M may have be a plurality of card ID's and this plurality of card ID's may be stored in the card ID storage means 133.

FIG. 4(b) is an example of a schematic structural diagram of the memory card N 135. The memory card N 135 includes an input and output means 136, an image storage means 137, a card ID storage means 138, and a card NID storage means 139. In the example shown in FIG. 4 (b), MIDn, which is the card ID of the memory card N 135, is stored in advance in the card storage means 138. In the present embodiment, it is assumed that the contents of the card ID storage means 138 cannot be read from the information terminal A. The card NID storage means 139 is a storage means for storing NIDn, which is a card NID of the memory card N135 generated by imaging terminal Q145 in step S1006 described below. MIDn, which is the card ID of the memory card N, may be an ID provided in advance to the memory card N such as a code or a serial number, which represents the maker, factory, or a production facility, or the like of a memory card. In addition, here, the memory card N is shown as an example of having one card ID MIDn, however, the memory card N may have be a plurality of card ID's and this plurality of card ID's may be stored in the card ID storage means 138.

In the explanation according to the present embodiment, the reason for assuming that the contents of the card ID storage means 133 and 138 cannot be read by the information terminal A is explained. An SD card is the most generally device used for storing image information. For example, most SD cards are in a state where information which can uniquely specify the SD card such as manufacturer, manufacture information, a serial number, or the like is not deleted even if the card is formatted. However, most personal computers which are an example of an information terminal recognize an SD card as a USB (Universal Serial Bus) Mass storage. As a result, an ID for uniquely specifying an SD card often cannot be read from a usual personal computer. In this way, not being able to read a card ID stored in a card ID storage means is a usual matter. Therefore, in the explanation according to the present embodiment of the present invention, it is assumed that the contents of the card ID storage means 133 and 138 cannot be read by the information terminal A. However, the effects of the present invention are achieved regardless of whether the contents of the card ID storage means 133 and 138 can be read or cannot be the information terminal A.

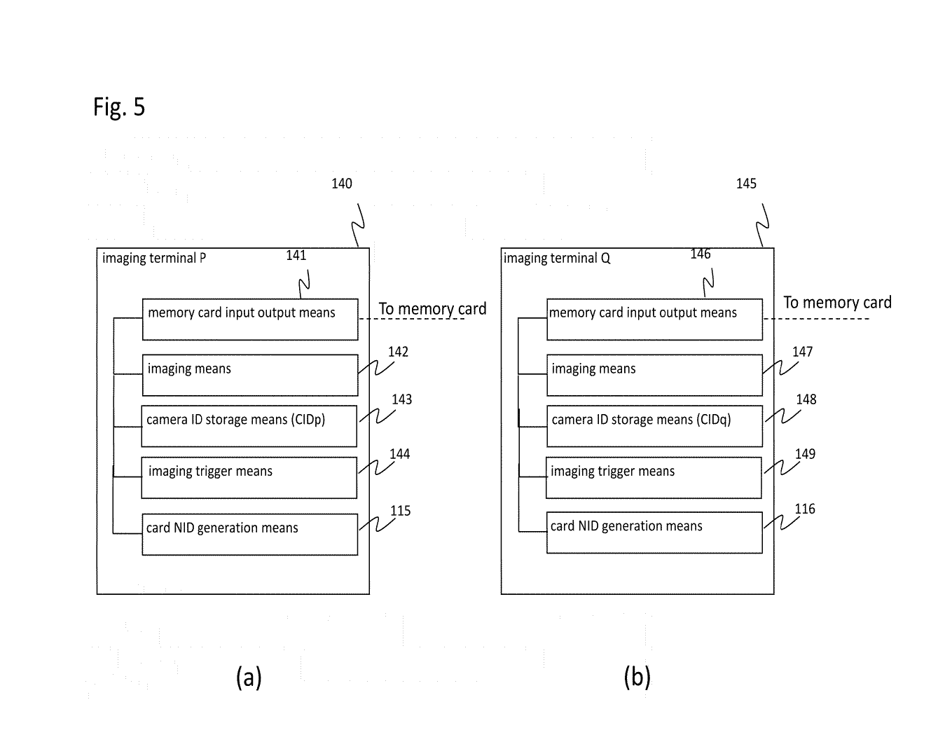

FIG. 5 is an example of a schematic structural diagram of the imaging terminal P 140 and the imaging terminal Q 145. The imaging terminal P 140 includes a memory card input and output means 141, an imaging means 142, a camera ID storage means 143, an imaging trigger means 144, and a card NID generation means 115. The imaging terminal Q includes a memory card input and output means 146, an imaging means 147, a camera ID storage means 148, an imaging trigger means 149, and a card NID generation means 116.

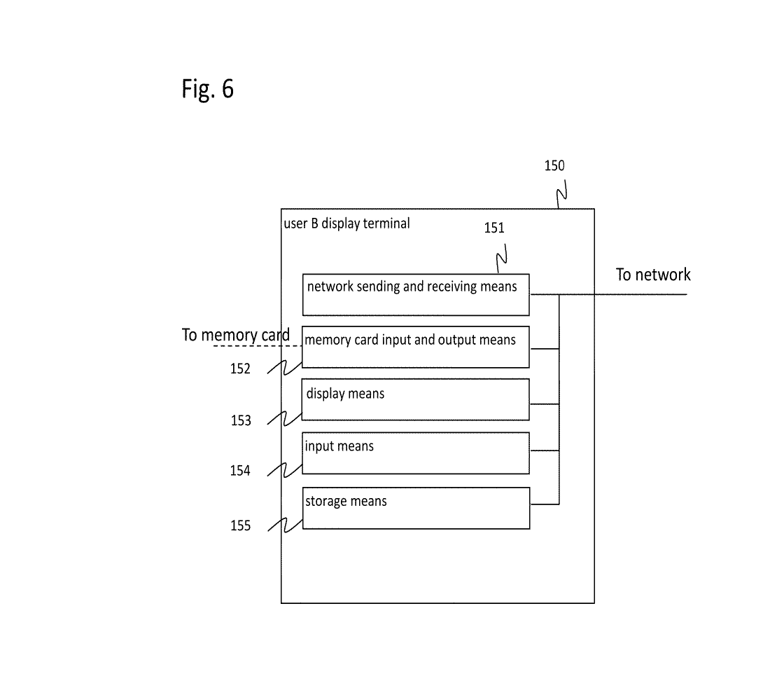

FIG. 6 is an example of a schematic structural diagram of the display terminal B 150. The display terminal B 150 includes a network sending and receiving means 151, a memory card input and output means 152, a display means 153, an input means 154, and a storage means 155.

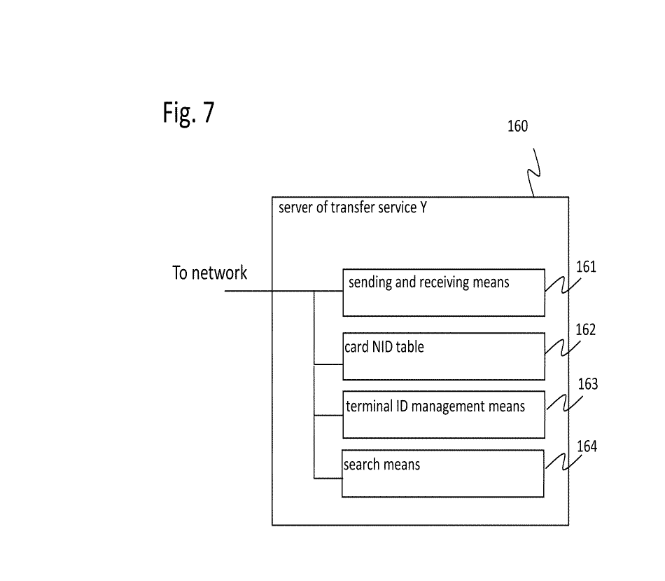

FIG. 7 is an example of a schematic structural diagram of the server Y 160. The server Y 160 includes a sending and receiving means 161, a card NID table 162, a terminal ID management means 163, and a search means 164.

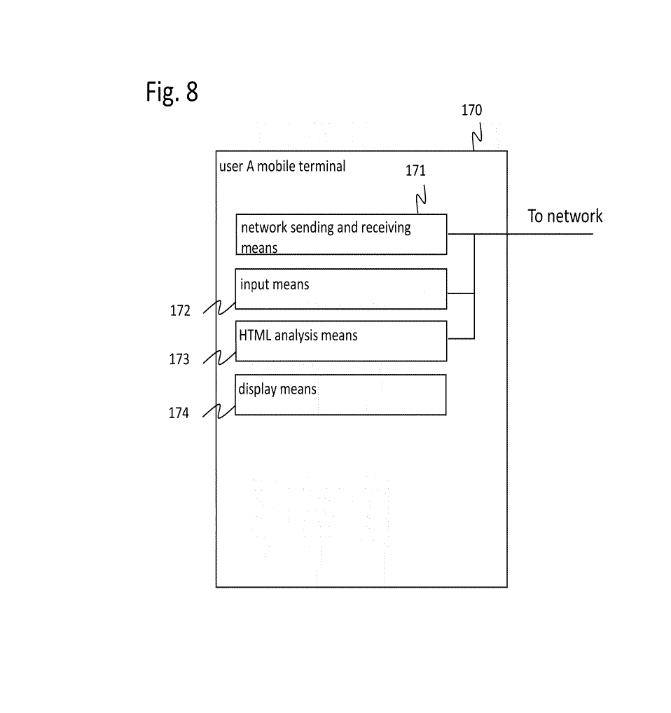

FIG. 8 is an example of a schematic structural diagram of the mobile terminal A 170. The mobile terminal A 170 includes a network sending and receiving means 171, an input means 172, an HTML analysis means 173, and a display means 174.

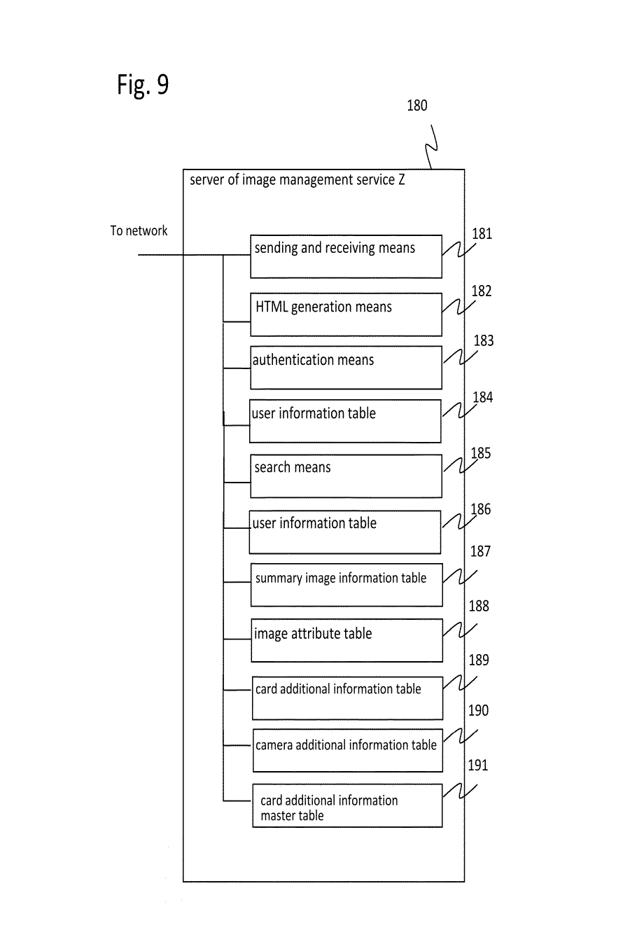

FIG. 9 is an example of a schematic structural diagram of the server Z 180. The server Z 180 includes a sending and receiving means 181, an HTML generation means 182, an authentication means 183, a user information table 184, a search means 185, a user information table 186, a summary image information table 187, an image attribute table 188, a card additional information table 189, a camera additional information table 190, and a card additional information master table 191.

In the present specification, image information taken by an imaging device and stored in an image storage means of a memory card is a source image. In addition, an image obtained by processing a source image is referred to as a processed image of the source image. In the source image or the processed image of the source image, when two images are compared, an image with a large amount of information is referred to as an original image and an image with a small amount of information is referred to as a summary image. For example, when an original image with the RAW format is converted to a JPEG format (Joint Photographic Experts Group) with less information, the original image is an entity image and a processed image of this original image is a summary image. Furthermore, in the case where two processed images are generated from the original image, a processed image with a large amount of information is the entity image and the processed image with a small amount of information is the summary image. If the entity image is image information stored in the image storage means of an imaging terminal, then the image may be any image format such as RAW format, JPEG format, TIFF (Tagged Image File Format) format, or GIF (Graphics Interchange Format). The summary image may also be any image format such as JPEG format, RAW format, PNG (Portable Network Graphic) format, TIFF (Tagged Image File Format) format, or GIF format.

Three embodiments of the present invention are exemplified below. A summary of each embodiment is as follows. In the first embodiment, the user A takes images using the imaging terminal P 140 and the imaging terminal Q 145, and following this, an image group stored in the memory cards M 130 and N 135, the information terminal A 100 and the server X 120 are managed by the information terminal A 100. In the second embodiment, the information terminal A 100 obtains the card ID for identifying memory card N 135 in a state where the memory card N 135 is connected to the information terminal A 100, next, the information terminal A 100 sends the image information to the memory card N 135 via the network 199 and the display terminal B 150 in a state where the memory card N135 is connected to the display device B 150, and the image information is displayed on the display terminal B 150. In the third embodiment, a correlation of summary image information and an original image storage destination is held in the server Z 180 and the user A performs similar image management as in Embodiment 1 through a Web browser of the mobile terminal A 170.

### Embodiment 1

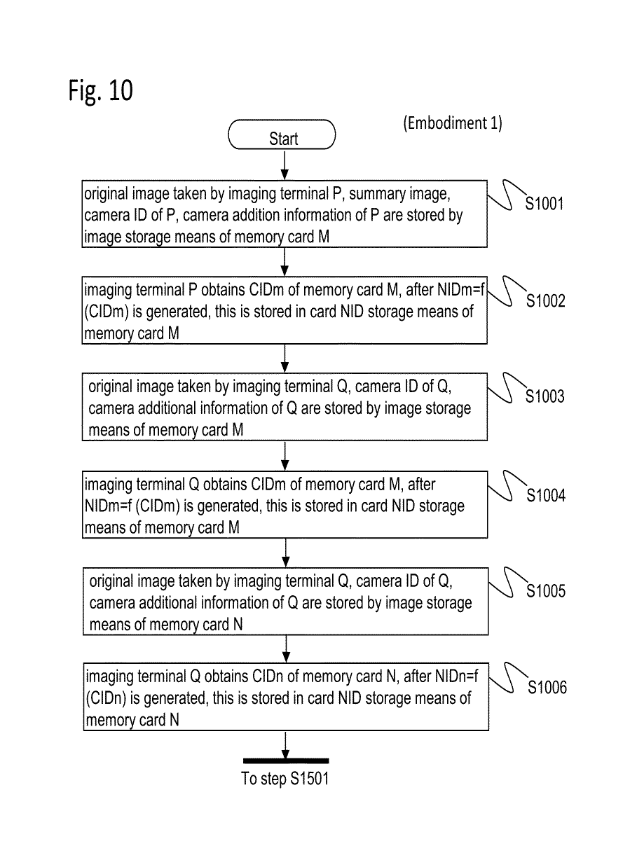

An example of an embodiment of the present invention is explained using the flow diagram in FIG. 10. The user A operates the imaging trigger means 144 in a state where the memory card M 130 is connected to the memory card input and output part 141 of the imaging terminal P 140. Via this operation, the imaging means 142 generates original image information and an original image ID for uniquely identifying each original image information, summary image information corresponding to each original image and a summary image ID for uniquely identifying each summary image information, sends these to the image storage means 132 via the memory card input and output means 141 of the imaging terminal P140 and the input and output means 131 of the memory card M130, and the image storage means 132 correlates and stores these. In addition, a camera ID for uniquely identifying the imaging terminal P 140 and camera additional information, which are stored in the camera ID storage means 143 of the imaging terminal P 140, are correlated with original image information and corresponding original image ID and stored via the memory card input and output means 141 and the input and output means 131 of the memory card M 130 (step S1001).

On the other hand, the memory card input and output means 141 of the imaging terminal P 140 obtains MIDm, which is a card ID of the memory card M 130 stored in the card ID storage means 133 via the input and output means 131 of the memory card M130. Next, the card NID generation means 115 of the imaging terminal P 140 generates a card NID of the memory card M by performing an arbitrary calculation or conversion of the obtained MIDm. When the card NID of the memory card M generated here is given as NIDm, NIDm=f (MIDm) with an arbitrary calculation or a conversion as f. The calculation or conversion f may be any calculation or conversion such as identify mapping or so that NID=MIDm. In addition, in the case where there is a k number of card ID's of the memory card M, MIDm1, MIDm2, . . . MIDmk, then the parameter NIDm=f (MIDm1, MIDm2, . . . MIDmk) may be k number of calculations or conversions. NIDm may be any card NID as long as it can uniquely specify the memory card M among the memory cards linked to an information terminal, a mobile terminal, or a display terminal connected to the network 199 in the present embodiment. Next, the memory card input and output means 141 of the imaging terminal P sends NIDm generated by the card NID generation means 115 to the memory card M. The card NID storage means 134 of the memory card M stores NIDm received from the imaging terminal P (step S1002). The step S1002 may be performed before step S1001.

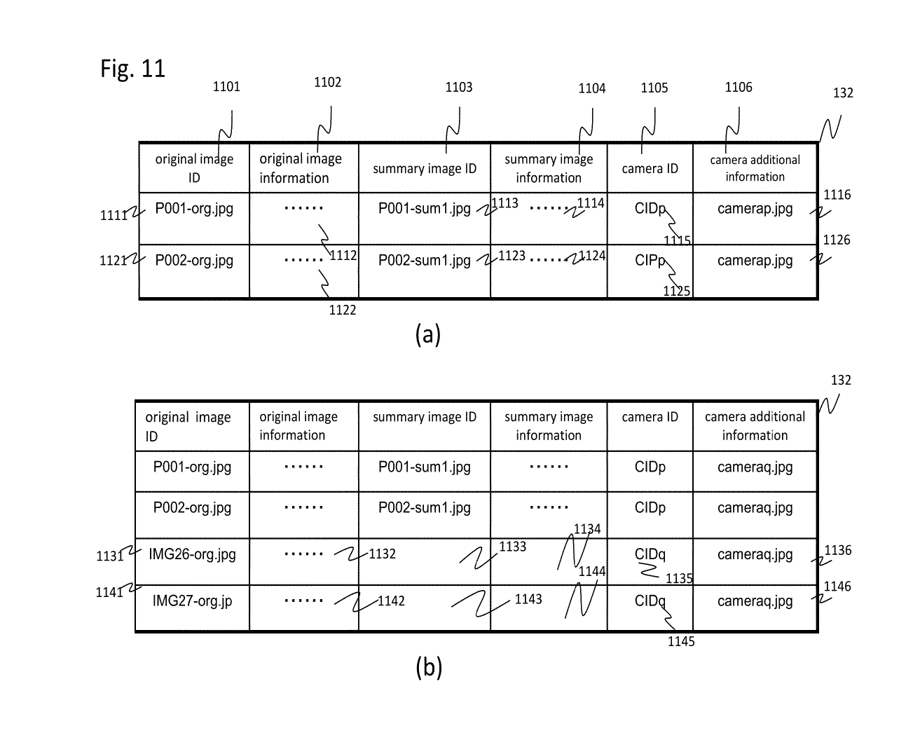

FIG. 11 (a) shows an example of information stored in the image storage means 132 of the memory card M after step 1001. The image storage means 132 includes an original image ID column 1101, an original image information column 1102, a summary image ID column 1103, a summary image information column 1104, a camera ID column 1105, and a camera additional information column 1106. In the example in FIG. 11 (a), an original image ID 1111 and original image information 1112 represented by 1121 and 1122 are stored. Below, the original image information and summary image information are denoted as “ . . . ”. Original image information and summary image information may be information of any format such as RAW, JPEG, TIFF, PNG, and GIF. In FIG. 11 (a), for example, the original image information 1112 correlated with the original image ID 1111, summary image ID 1113, the summary image information 1114, the camera ID 1115, and the camera additional information 1116 are correlated and stored. Here, the summary image ID, the summary image information, the camera ID, and the camera additional information do not have to be stored. In the embodiments, although an original image ID and a summary image ID are treated as different ID's, in the present invention, an ID which indicates an original image and an ID which indicates a summary image correlated with this original image may be common ID's. Furthermore, in FIG. 11, there may be a plurality of groups of the summary image ID column 1103 and the summary image information column 1104. That is, one original image may have a plurality of summary images. In the case where an original image has a plurality of summary images, three summary images with high resolution, intermediate resolution and low resolution respectively are correlated with one original image and stored in advance in the image storage means 132 and the summary images to be used can be used separately according to the transmission speed of the network. In addition, the image storage means 132 does not have to have the table format shown as in FIG. 11, but may be of any structure as long an original image ID, original image information, a summary image ID, and summary image information are correlated and stored.

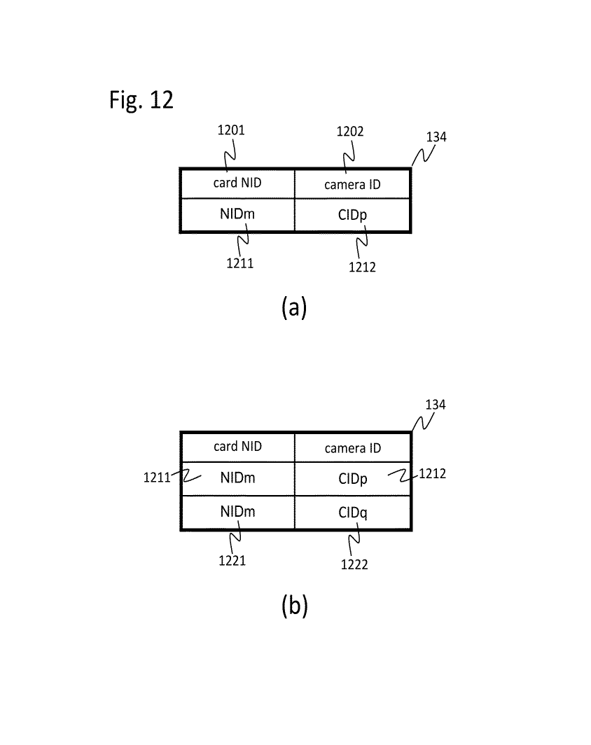

In addition, an example of information stored by the card NID storage means 134 of the memory card M after the process in step S1002 is shown in FIG. 12 (a). The card NID storage means 134 includes a card NID column 1201 and a camera ID column 1202. After the process in step S1002, NIDm 1211 and CIDp 1212 received from the imaging terminal P are correlated and stored.

Next, the user A extracts the memory card M130 from the imaging terminal P140, connects to the imaging terminal Q145 and operates the imaging trigger means 149. Via this operation, the imaging means 147 generates original image information and an original image ID for uniquely identifying each original image information, and these are correlated and stored in the image storage part 132 via the memory card input and output means 146 and the input and output means 131 of the memory card M 130. In addition, a camera ID for uniquely identifying the imaging terminal Q 145 and camera additional information stored by the camera ID storage means 148 are sent to the image storage means 132 via the memory card input and output means 146 and the input and output means 131 of the memory card M130. In addition, the image storage means 132 correlates and this camera ID and camera addition information with an original image ID (step S1003). In this example, although the imaging means 142 of the imaging terminal P generates summary image information and a summary image ID, it is assumed that the imaging means 147 of the imaging terminal Q 145 does not generate summary image information and a summary image ID.

On the other hand, the memory card input and output means 146 of the imaging terminal Q 145 obtains MIDm, which is the card ID of the memory card 130 stored in the card ID storage means 133, via the input and output means 131 of the memory card 130. Next, the card NID generation means 116 of the imaging terminal Q 145 generates a card NID of the memory card M by performing the calculation of MIDm or conversion f used in step S1002. When the card NID of the memory card M 130 generated here is given as NIDm, NIDm=f (MIDm) as the calculation or conversion f. In addition, in the case where the card ID of the memory card M130 has a k number of ID's MIDm1, MIDm2, . . . MIDmk, then the parameter NIDm=f (MIDm1, MIDm2, . . . MIDmk) may be a k number of calculations or conversions. Next, the memory card input and output means 146 of the imaging terminal Q145 sends NIDm generated by the card NID generation means 116 to the memory card M130. The card NID storage means 134 of the memory card M 130 correlates and stored NIDm and CIDq received from the imaging terminal Q 145 (step S1004). Step S1004 may also be performed before step S1003.

An example of information stored in the image storage means 132 of the memory card M130 after step 1003 is shown in FIG. 11 (b). In the example in FIG. 11 (b), in addition to the information that is stored in FIG. 11 (a), original image information 1132 and 1142, the camera IDs 1135 and 1145, and the camera additional information 1136 and 1146 are each correlated with the original image ID 1131 and 1114 respectively and stored. In this example, because the imaging means 147 of the imaging terminal Q 145 does not generate summary image information and a summary image ID, in FIG. 11(b), summary image IDs 1133 and 1143 corresponding with the original image IDs 1131 and 1141 respectively, and summary image information 1134 and 1144 become information (a NULL value for example) corresponding to a blank.

In the example in FIG. 11, the original image ID and the summary image ID are comprised from a common part and an additional part. For example, the original image ID 1111 is comprised from of a common part “P001” and an additional part “−org”. In addition, the summary image ID 1113 corresponding to this original image is composed of common part “P001” and additional part “−sum1”. In this case, the additional part “−org” indicates an original image and “−sum1” indicates a summary image. In this way, it is possible to detect that original image information 1112 and an original image 1114 have been generated from the same original image just from ID information. In addition, in the present invention there may be a plurality of processed images obtained by processing an original image. As a result, the properties of the processed image may be included in the additional part of the summary image ID. For example, the additional portion “−sum2” may be used for high resolution summary image and the additional part “−sum1” may be used for a low resolution summary image. An additional part may include not only resolution information but also information indicating chromaticity, white balance, brightness, image rotation and the content of processing an original image such as coordination. In addition, the original image ID and summary image ID may be of any format as long as they contain information which can detect that certain original image information and certain summary image information are generated from the same original image even without a combination of additional parts and common parts.

In addition, an example of information stored in the image storage means 134 of the memory card M after step 1004 is shown in FIG. 12 (b). In addition to the stored NIDm 1211 and CIDp 1212 received from the imaging terminal P in step S1002, the stored NIDm 1221 received from the imaging terminal Q in step S1004 is correlated and stored with CIDa 1222 of the imaging terminal Q.

NIDm 1211 and NIDm 1221 stored in the state in FIG. 12(b) are both derived from the calculation or conversion f using MIDm stored in the card ID storage means 133 of the memory card M and are usually the same value. Despite this, as is shown in FIG. 12(b), the reasons why NIDm 1211 is correlated and stored with CIDp 1212 or NID 1221 with CIDq 1222 in the card storage means is that in the case where there is an error in the process of the card NID generation means of the imaging terminal Q or where a card NID is created with the intention of fabrication by the imaging terminal Q for example, the imaging terminal A 100 or the server 180 can detect this inconsistency in the following processes.

The method of the present invention is effective in the case where MIDm can be directly read or in the case where MIDm cannot be read in the state where the information terminal A 100 is connected to the input and output means 131 of the memory card M130. Although in reality most SD cards store information for uniquely specifying the SD cards, an SD card cannot be read using a generally available personal computer or a SD card reader of a mobile phone. According to the present invention, it is possible for each imaging terminal to store NID generated from MIDm in the card NID storage means 134 by allowing the imaging terminal P 140 and the imaging terminal Q 145 to read MIDm in advance even in the case where the information terminal A cannot directly read MIDm from the memory card M 130. Even if information terminal A cannot read the information in the card ID storage means 133, if it is possible to read the information in the card NID storage means 134, it is possible to obtain NIDm, which can uniquely specify the memory card M130. That is, in the method of the present invention, because NIDm for uniquely specifying the memory card M is generated by each imaging terminal, it is useful to provide information to allow the information terminal A to verify the validity of the generation process of NIDm in each imaging terminal. As is shown in FIG. 12 (b), this is the reason for correlating and storing NIDm generated by each imaging terminal with CID of each information terminal.

Next, the user A connects memory card N 135 to the imaging terminal Q 145 instead of the memory card M 130 and operates the imaging trigger means 149. Via this operation, the imaging means 147 generates original image information and an original image ID for uniquely identifying each original image information, and these are sent to the memory card N 135 by the input and output means 146 of the imaging terminal Q 145. When the input and output means 136 of the memory card N 136 receives these, the image storage means 135 correlates and stores the image ID with the received original image information. In addition, the camera ID for uniquely identifying the imaging terminal Q 145 and the camera additional information stored in the camera ID storage means 148 of the image terminal Q 145 are sent to the image storage means 137 via the memory card input and output means 146 and the input and output means 136 of the memory card N135. In addition, the image storage means 137 correlates and stores the camera ID and camera additional information with an original image ID (step S1005).

However, the memory card input and output means 146 of the imaging terminal Q 145 obtains MIDn, which is the card ID of the memory card 135 stored in the card ID storage means 138, via the input and output means 136 of the memory card 135. Next, the card NID generation means 116 of the imaging terminal Q 145 generates a card NID of the memory card N by performing the calculation or the conversion f of MIDn used in step S1002 and step S1004. When the card NID of the memory card N generated here is given as NIDn, NIDn=f(MIDm) by the calculation or conversion f. In addition, in the case where the card ID of the memory card N has k number of ID's MIDn1, MIDn2, . . . MIDnk, then the parameter NIDn=f (MIDn1, MIDn2, . . . MIDnk) may be k number of calculations or conversions. Next, the memory card input and output means 146 of the imaging terminal Q 145 sends NIDn generated by the card NID generation means 116 to the memory card N. The card NID storage means 139 of the memory card N135 correlates and stores a camera ID with NIDn received from the imaging terminal Q 145 (step S1006). Step S1006 may also be performed before step S1005.

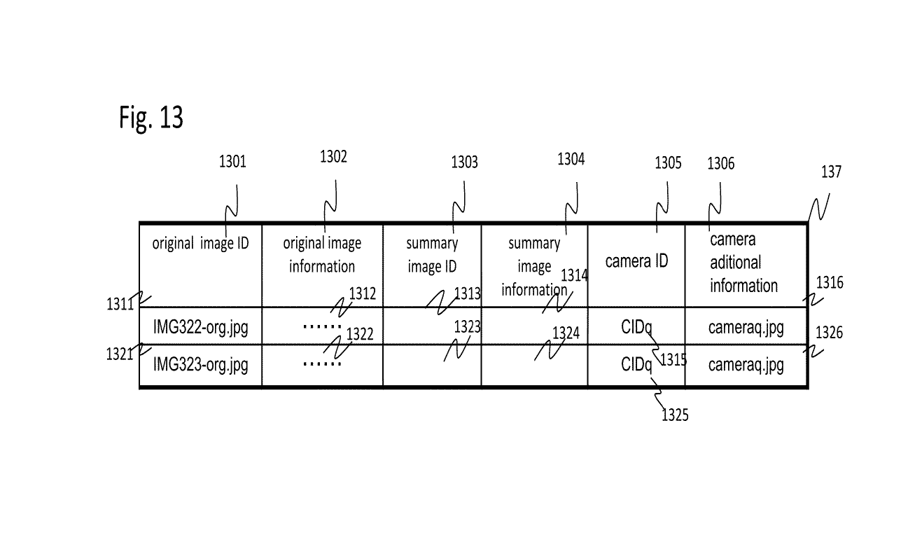

An example of information stored in the image storage means 137 of the memory card N after step S1005 is shown in FIG. 13. The image storage means 137 includes an original image ID column 1301, an original image information column 1303, a summary image ID column 1303, a summary image information column 1304, a camera ID column 1305, and a camera additional information column 1306. In the example in FIG. 13, the original image information 1312 and 1322 represented by the original image IDs 1311 and 1321 are stored. In addition, the camera IDs 1315 and 1325 of the imaging terminal which took these images and also the camera additional information 1316 and 1326 are stored. There may be a plurality of groups consisting of the summary image ID column and the summary image information column in FIG. 13. In addition, the image storage means 137 does not need to be the table format shown in FIG. 13, and may have any structure as long as an original image ID, original image information, a summary image ID, and summary image information are correlated and stored. In this example, because the imaging means 147 of the imaging terminal Q does not generate summary image ID and summary image information, the summary image IDs 1313 and 1323 corresponding to the original image 1321 and ID 1312 respectively, and the summary image information 1314 and 1324 become information corresponding to a blank (empty value for example).

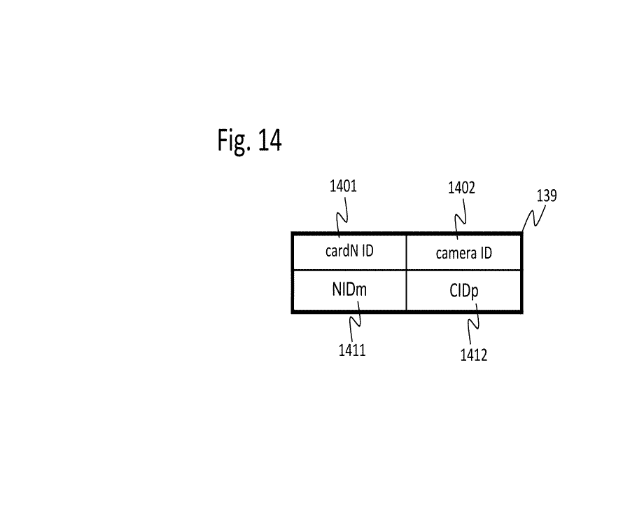

In addition, an example of information stored in the card NID storage means 130 of the memory card N 135 after the process in step S1006 is shown in FIG. 14. The card NID storage means 139 includes a card NID column 1401 and a camera ID column 1402. After the process in step S1006, NIDn 1411 received from the imaging terminal Q 145 is correlated and stored with CIDq 1412 which is a camera ID.

In the process described above, an image taken by the imaging terminal P 140 is stored in the memory card M 130, and an image taken by the imaging terminal Q 145 is stored in the memory cards M 139 and N135. A user often uses a plurality of cameras and a plurality of memory cards when storing images in this way which is common in photography.

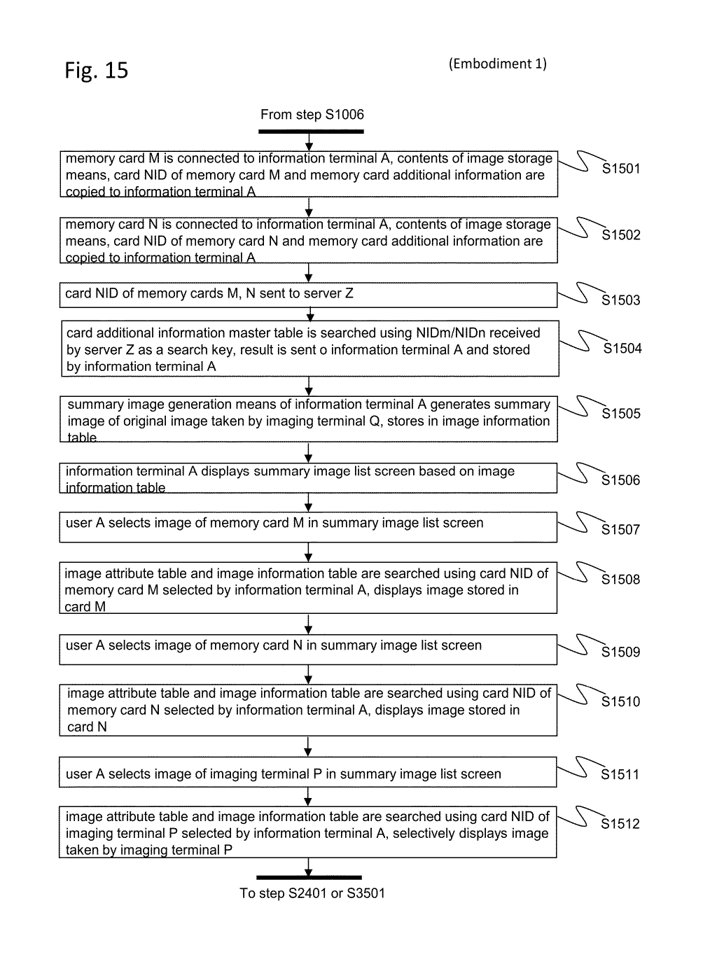

Next, the image processes in the information terminal A are explained using the flowchart shown in FIG. 15. The user A connects the memory card M 130 to the input and output means 102 of the information terminal A 100. Then, the input and output means 131 of the memory card M130 sends an original image ID, original image information, a summary image ID, summary image information, a camera ID, and camera additional information, as in the state shown in FIG. 11(b), to the information terminal A 100. Furthermore, the input and output means 131 of the memory card M 130 sends card NIDs 1211 and 1221 of the memory card M 130 stored in the state shown in FIG. 12(b) in the card NID storage means 134, and the camera ID 1212 to the information terminal A. When the input and output means 102 of the information terminal A 100 receives these, original image information correlated with an original image ID, a summary image ID, and summary image information are correlated and stored in the image information table 103. In addition, the card NID and the camera ID, received from the memory card M 130, are stored in the image attribute table 104 and correlated with the original image ID. Furthermore, the camera ID and the card additional information are correlated and stored in the card additional information table 109 (step S1501).

Next, the user A connects the memory card N 135 to the input and output means 102 of the information terminal A 100. Then, the input and output means 136 of the memory card N 135 sends the original image ID, the original image information, the summary image ID, the summary image information, the camera ID, and the camera additional information, as in the state shown in FIG. 13, to the information terminal A100. Furthermore, the input and output means 136 of the memory card N 135 sends the card NID 1411 and the camera ID 1412 of the memory card N 135 stored in the state shown in FIG. 14 in the card ID storage means 139, to the information terminal A. When the input and output means 102 of the information terminal A 100 receives these, the original image information correlated with the original image ID, the summary image ID, and the summary image information are correlated and stored in the image information table 103. In addition, the card NID and the camera ID received from the memory card N 135 correlated with the original image ID in the image attribute table 104 are stored. Furthermore, the camera ID and camera additional information are correlated and stored in the camera additional information table 109 (step S1502). Furthermore, the information in the image information table 103 and the image attribute table 104 may also be stored in one table.

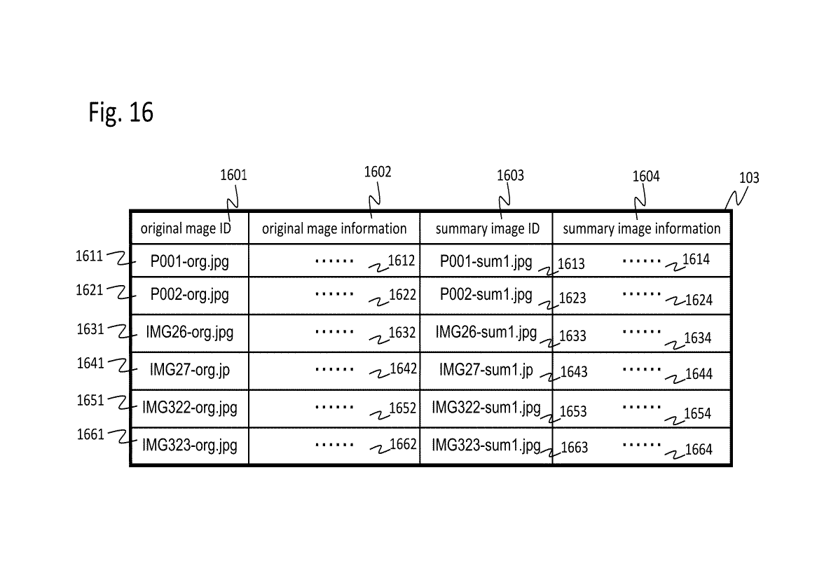

An example of the original information table 103 after step S1502 is shown in FIG. 16. Original image IDs 1611, 1621, 1631, and 1641 and original image information 1612, 1622, 1632, and 1642, which is specified by these original image IDs, and summary image IDs 1613 and 1623, and summary image information 1614 and 1624, which is specified by these summary image IDs respectively is information that is copied from the image storage means 132 of the memory card M130 in step S1501. Similarly, original image IDs 1651 and 1661, and original image information 1652 and 1362 which are specified by these image IDs is information that is copied from the image storage means 137 of the memory card N135 in step S1502. At the time when step S1502 is executed, summary image IDs 1643, 1653, and 1663, and summary image information 1634, 1644, 1654, and 1664 which are specified by these summary image IDs is information corresponding to a blank. These summary image IDs and summary image information are generated in the nest step S1505 and stored in the image information table 103. FIG. 16 shows the state after step 1505 is executed.

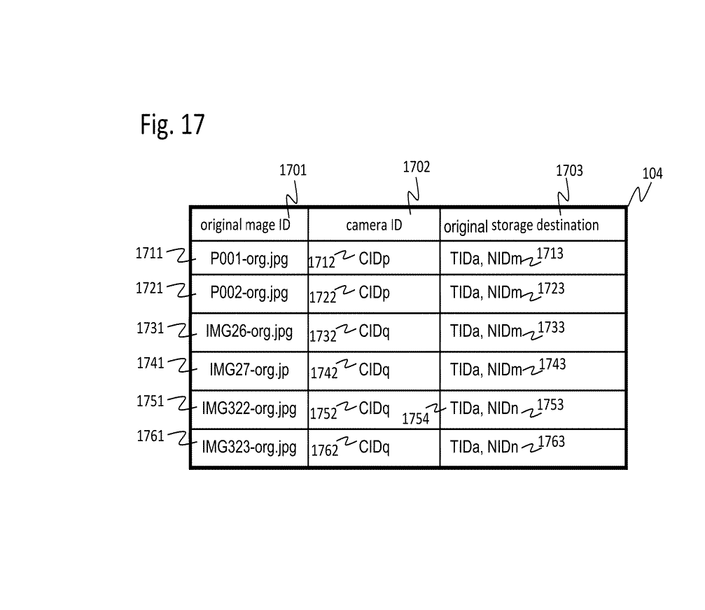

An example of an image attribute table 104 after step S1502 is shown in FIG. 17. Camera IDs 1712, 1722, 1732, and 1742 are camera IDs copied from the image storage means 132 of the memory card M130. In addition, camera IDs 1752 and 1762 are camera IDs copied from the image storage means 137 of the memory card N135. Original image storage destinations 1713, 1723, 1733, and 1743 are card IDs copied from the card NID storage means 135 of the memory card M130. In addition, original image storage destinations 1753 and 1763 are card NIDs copied from the card ID storage means 139 of the memory card N135. In FIG. 17, the camera ID column 1702 represents which imaging terminal took each image, and the original storage destination column 1703 represents in which memory card original images are stored. Via the processes in step S1501 and S1502, all of the original images of the original image IDs 1611, 1621, 1631, 1641, 1651, and 1661 were stored in the image information table 103 of the information terminal A100. TIDa, which is a terminal ID for uniquely identifying the information terminal A 100, is stored in the original storage column 1703 in the image attribute table 104 as all of these original storage destinations. In FIG. 17, for example, storing TIDa 1754 and NIDm 1753 being stored in the original storage destination 1703 of the original image ID 1751 row indicates that the original image information is stored in both the information terminal A and the memory card N.

An original image ID and a summary image ID are generated by the imaging terminal P 140 and the imaging terminal Q 145 and stored in the image information table and the attribute image table of the information terminal A100. In the present embodiment, original image information and summary image information are assumed to be able to be uniquely identified among all images stored by the information terminal A 100 using an original image ID and a summary image ID respectively. Actually, with respect to different image information, there is a possibility that the imaging terminal P 140 and the imaging terminal Q 145 generate the same original image ID. In this case, a problem occurs wherein an original image to be searched cannot be uniquely identified even if the image attribute table 104 and the image information table 103 are searched using an original image ID as a search key. In this way, in the case where the uniqueness of an original image ID and a summary image ID cannot be guaranteed, a global ID column is added to the image information table 103 shown in FIG. 16 and the image attribute table 104 shown in FIG. 17. Furthermore, in step S1501 and step S1502, a global ID generation means 112 of the information terminal A 100 generates a global ID for uniquely identifying each original image information and the global ID is correlated with each original image ID and summary image ID stored in advance. In this case, in each step below, by using a global ID as a search key instead of an original image ID, it is possible to solve the problem in the case where it is not possible to uniquely identify the original image information using an original image ID. In addition, in the case where the uniqueness of an original image ID has been guaranteed within an imaging terminal, it is possible to guarantee the uniqueness of the image information in the information terminal A by a combination of a camera ID and the original image ID generated by the imaging terminal. Hereinafter, an explanation is given assuming that the uniqueness of an original image ID generated by an imaging terminal is guaranteed with each imaging terminal. Therefore, it is possible to uniquely identify original image information and the summary image information using a combination of an original image ID and a camera ID without using a global ID.

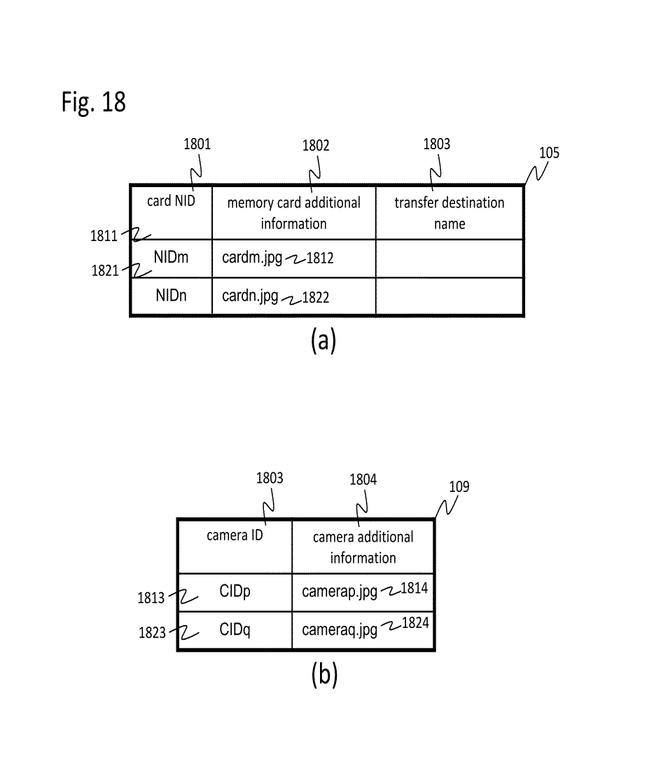

An example of a card additional information table 105 after step S1502 is shown in FIG. 18 (a). The card additional information table 105 is comprised from a card NID column 1801, a memory card additional information column 1802, and a transfer destination name column 1803. The transfer destination name column is used in the second embodiment described below. The card NID 1811 obtained from the memory card M 130 in step S1501 is correlated with memory card additional information 1812 of the memory card N 135 and stored in the card NID column. The memory card additional information column 1802 receives memory card addition information from each memory card from the server Z in step S1504 described below and the information shows a blank until it is stored.

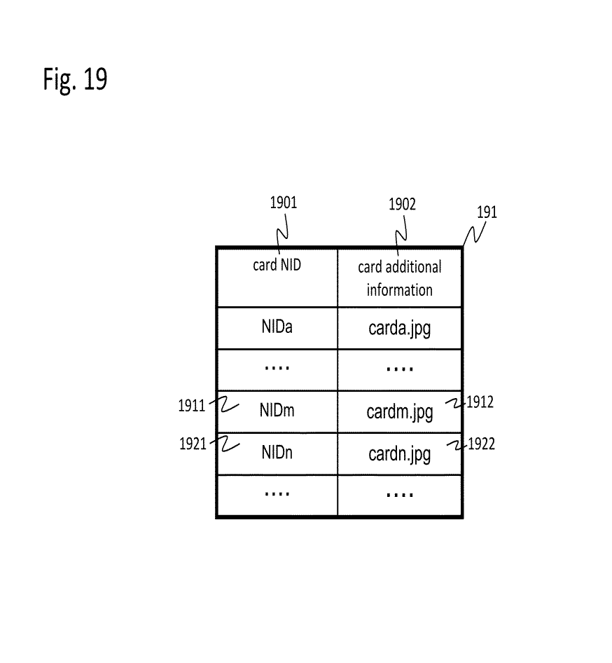

Next, the network sending and receiving means 101 of the information terminal A100 sends the card NIDs 1811 and 1821 stored in the card additional information table 105 to the server Z180 via the network 199 (step S1503). When the sending and receiving means 181 of the server Z receives these, the search means 185 searches the card additional information master table 191 using the card NIDs received from the information terminal A100 as search keys. An example of card additional information master table 191 is shown in FIG. 19. The card additional information master table 191 includes a card NID column 1901 and a card additional information column 1902. The card additional information master table 191 stores the corresponding relationship between a card NID and card additional information and handles the task of returning card additional information to an information terminal which has obtained a card NID. In the example shown in the present embodiment, the card additional information 1912 and 1922 correlated with card NIDs 1991 and 1921 respectively are obtained as a search result. Next, the sending and receiving means 181 of the server Z sends cardm.jpg and cardn.jpg which are search results to the information terminal A 100 via the network 199. Here, an explanation has been given of an example where the server Z 180 contains the card additional information master table and responds to requests of card additional information from the information terminal A 100. However, in the present invention, the process of responding to a query of card additional information from an information terminal may also be performed by a different server connected to the network 199. In addition, the card additional information table may also store a correlation between a card ID stored in the card ID storage means of a memory card and card additional information. In this case, a card NID is derived by performing a reverse calculation of reverse conversion of f with respect to the card ID, the card ID is derived by performing a reverse calculation or reverse conversion of f from the card NID sent in step S1504 from information terminal A100 and using this card ID as a search key the card additional information to be sent to the information terminal A can be obtained by searching the card additional information master table.

Next, when the network sending and receiving means 101 of the information terminal A 100 receives the card NIDs of the memory card M 130 and N 135 from the server Z180, the card NIDs of each memory card are correlated and stored in the card addition information table 105 (step S1504). Again referring to FIG. 18(a), the memory card additional information 1812 correlated with the card NID 1811 of memory card M 130 and received from the server Z 180 or the memory card additional information 1822 correlated with the card NID 1821 of the memory card N 135 and received from the server Z 180 are stored. FIG. 18(a) shows the card additional information table 105 after the process in step S1505 is performed.

Furthermore, an example of camera additional information table 109 after step S1502 is shown in FIG. 18(b). The camera additional information table 109 is comprised of a camera ID column 1803 and camera additional information column 1804. The camera ID 1813 obtained from the memory cards M 130 and N 135 in step S1501 and S1502 is correlated with camera additional information 1814 of the imaging terminal P and stored. In addition, the camera ID 1823 obtained from the memory card N 130 in step S1502 is correlated with camera additional information 1824 of the imaging terminal Q 145 and stored.

At the stage where step S1504 is executed, summary image IDs 1633, 1643, 1653, and 1663, and summary image information which is specified these in FIG. 16 are blank. The reason for this is that the imaging means 147 of the imaging terminal Q does not generate summary image. Therefore, the original image generation means 108 of the information terminal A generates summary images from each original image information of 1632, 1642, 1652, and 1662 and stores them in the image information table 103 (step S1505). The summary image IDs 1633, 1643, 1653, and 1663, and summary image information 1634, 1644, 1654, and 1664 which are specified by these IDs in FIG. 16 are generated as a result of step S1505 and stored in the image information table 103. In an embodiment of the present invention, an imaging terminal may or may not generate summary image. In the case where an imaging terminal which does not generate a summary image such as imaging terminal Q, the summary image generation means 108 of information terminal A generates a summary image and stores the image in the image information table 103.

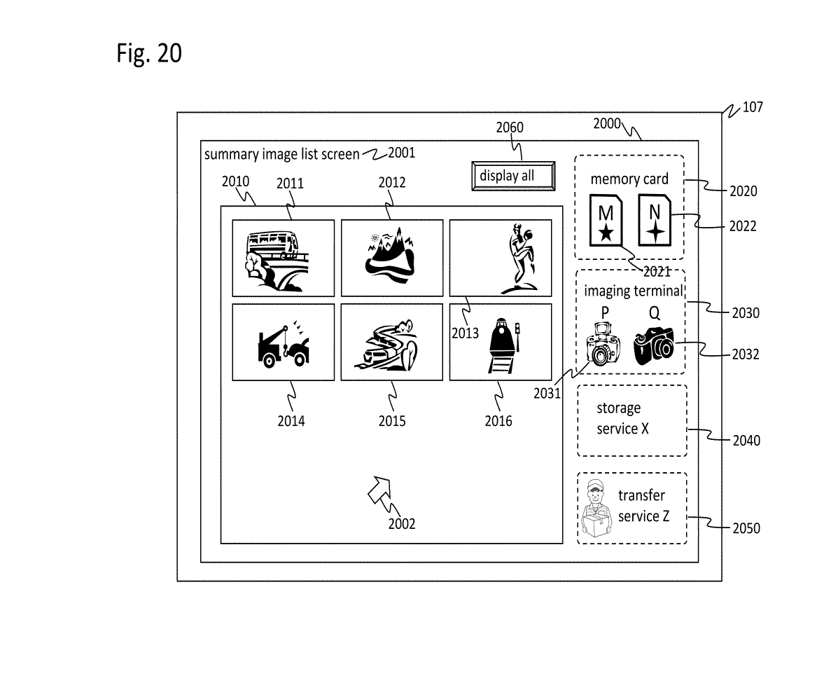

Next, when the user A instructs the information terminal A to display a screen image of a summary image list through the input means 106, the display means 107 displays the summary image list screen (step S1506). An example of the summary image list screen is shown in FIG. 20. The summary screen 2000 includes a display 2001 which shows that it is a summary image list screen, a cursor 2002 for specifying screen elements, a summary image display part 2010, a memory card display part 2020, an imaging terminal display part 2030, a storage service X display part 2040, a transfer service display screen 2050, and buttons 2060 for displaying all. In the example shown in FIG. 20, summary images 2011 to 2016 are displayed in the summary image display part 2010. These summary images show that original image information stored in the image information table 103 is displayed. The summary image information 1614, 1624, 1634, 1644, 1654, and 1664 shown in FIG. 16 correspond to the summary images 2011, 2012, 2013, 2014, 2015, and 2016 shown in FIG. 20 respectively. A memory card image 2021 of the memory card M 130 and a memory card image 2022 of the memory card N 135 are displayed in the memory card display part 2020. Each of these images show that image information of the memory card additional information 1812 and 1822 stored in the card additional information table 105 shown in FIG. 18 (a) are displayed by the display means 107. In addition, an appearance image 2031 of the imaging terminal P and an appearance image 2032 of the imaging terminal Q are displayed in the imaging terminal display part 2030. Each of these images show that image information of the memory card additional information 1814 and 1824 stored in the camera additional information table 109 shown in FIG. 18(b) are displayed by the display means 107.

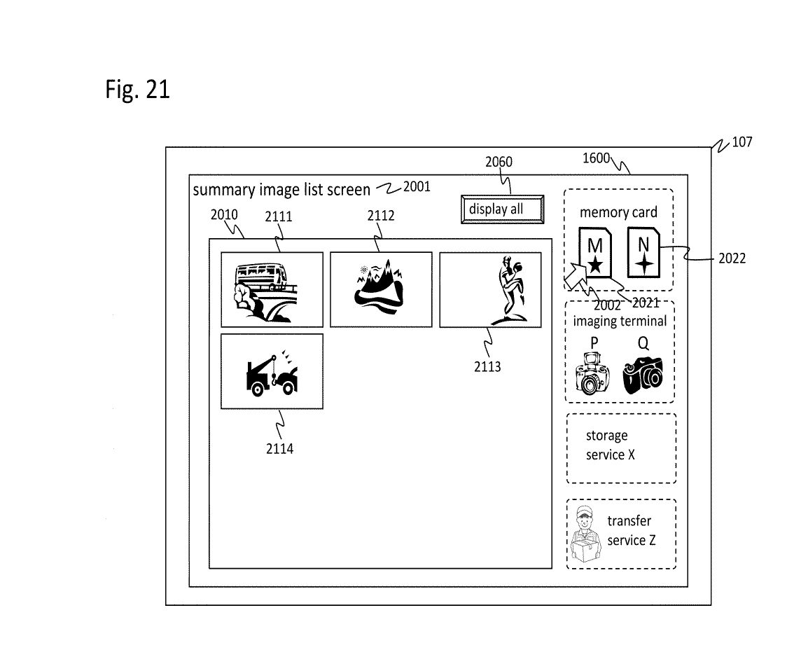

Next, the user A operates the input means 106 of the information terminal A 100, moves the cursor 2002 displayed on the display means 107, and selects the image 2021 of the memory card M 130 (step S1507). Then, the search means 110 searches the original storage destination column 1703 of the image attribute table 104 using NIDm, which is a card ID of the memory card M 130, as a search key. The original image IDs 1711, 1721, 1731, and 1741 are obtained as in the example in FIG. 17. These are original image IDs of original images stored in the memory card M 130 in addition to the information terminal A 100. Next, the search means 110 searches the image information table 103 using these original image IDs as search keys, and the search means 110 sends summary image information obtained as a result to the display means 107. Display means 107 displays the summary image information received here on the summary image display means 2010 (step S1508). In the example in FIG. 16, summary image information 1614, 1624, 1634, and 1644 are obtained as a search result and sent to the display means. As a result, the image displayed on the display means is shown in FIG. 21. Summary images 2111, 2112, 2113, and 2114 are displayed in the summary image display means 2010. These images show that the summary image information 1614, 1624, 1634, and 1644 in FIG. 16 are displayed. Via this operation, summary images of original images stored in the memory card M130 are selectively displayed in the summary image display means 2010.

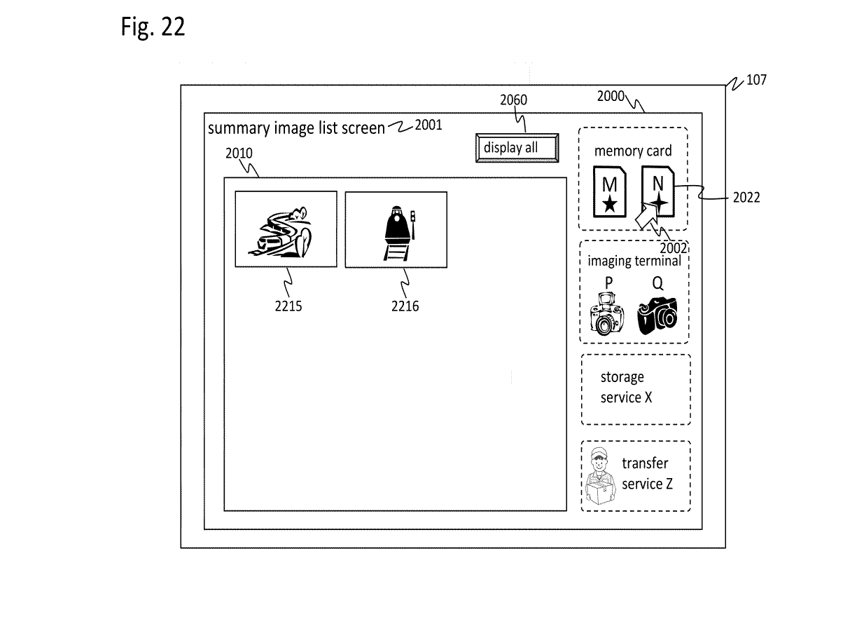

Next, the user A operates the input means 106 of the information terminal A100, moves the cursor 2002 displayed on the display means 107, and selects the image 2022 of the memory card N135 (step S1509). Then, the search means 110 searches the original image attribute table 104, and searches the original storage destination column 1703 using NIDn, which is a card ID of the memory card N 135, as a search key. The original image IDs 1751 and 1761 are obtained in the example in FIG. 17. These are original image IDs of original images stored in the information terminal A 100 and the memory card N 135. Next, the search means 110 searches the image information table 103 using these original image IDs as search keys, and the search means 110 sends summary image information obtained as a result to the display means 107. Display means 107 displays the summary image information received here on the summary image display means 2010 (step S1510). In the example in FIG. 16, summary image information 1654 and 1664 are obtained as a search result and sent to the display means. As a result, the image displayed on the display means is shown in FIG. 22. Summary images 2215 and 2216 are displayed in the summary image display means 2010. These images show that the summary image information 1654 and 1664 in FIG. 16 are displayed. Via this operation, summary images of original images stored in the memory card N135 are selectively displayed in the summary image display means 2010.

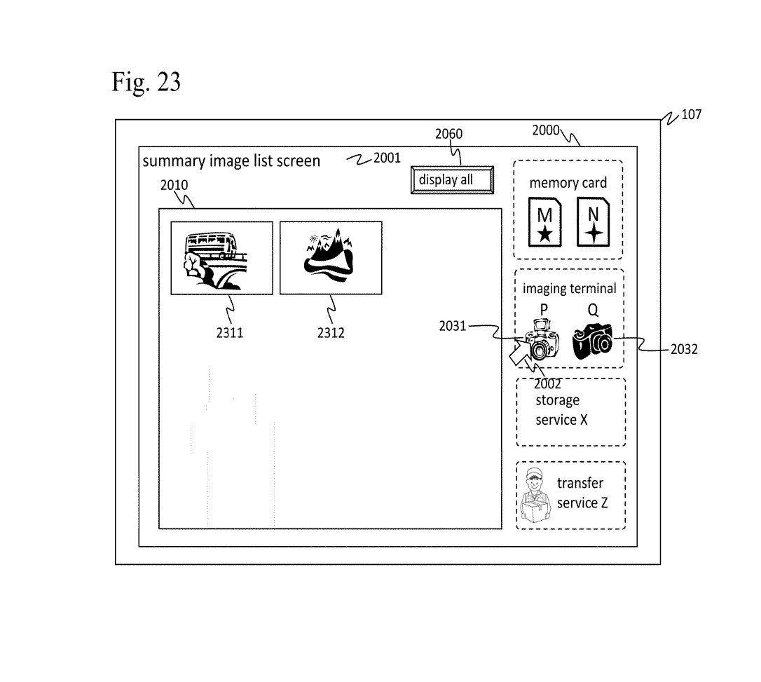

Next, the user A operates the input means 106 of the information terminal A100, moves the cursor 2002 displayed on the display means 107, and selects the image 2031 of the imaging terminal P (step S1511). Then, the search means 110 searches the original image attribute table 104, and searches the original storage destination column 1702 using CIDp, which is a card ID of the imaging terminal P140, as a search key. The original image IDs 1741 and 1721 are obtained in the example as in FIG. 17. These are original image ID's of original images taken by the imaging terminal P 140. Next, the search means 110 searches the image information table 103 using these original image IDs as search keys, and the search means 110 sends summary image information obtained as a result to the display means 107. Display means 107 displays the summary image information received here on the summary image display means 2010 (step S1512). In the example in FIG. 16, summary image information 1614 and 1624 are obtained as a search result and sent to the display means 107. As a result, the image displayed on the display means is shown in FIG. 23. Summary images 2311 and 2312 are displayed in the summary image display means 2010. These images show that the summary image information 1614 and 1624 in FIG. 16 are displayed. Via this operation, summary images of images taken by the imaging terminal P 140 are selectively displayed in the summary image display means 2010. Because the process where the user A selects image 2032 of the imaging terminal Q 145 in the summary image list screen is the same as in steps S1511 and S1512, an explanation of this process is omitted.

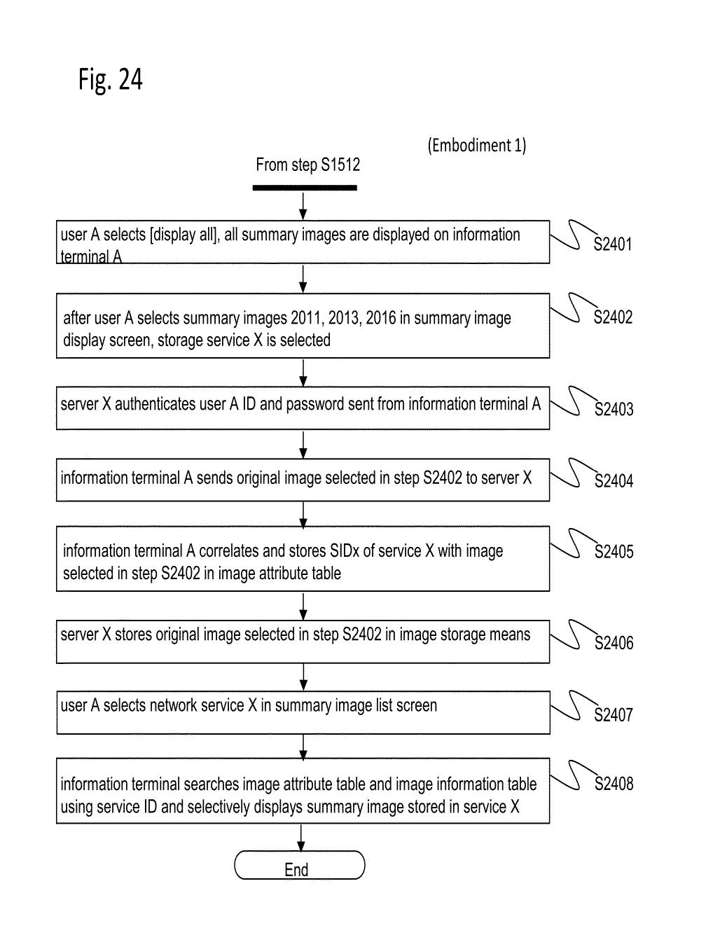

Next, embodiment one which is an embodiment of the present invention is explained using the flowchart shown in FIG. 24. The user A moves the cursor 2002 by operating the input means 106 of the information terminal A, and selects all the display buttons 2060 (step S2401). All of the display buttons 2060 can be selected at any time after step S1508. When this is selected, the summary image display means 2010 displays all the summary images stored in the image information table 103 by terminal A100.

According to the present invention, it is possible to perform the processes from step S1506 to step 1512 even in the case where there is no original image information in the image information table 103 in the information terminal A 100. For example, since the capacity of the storage device in the information terminal A100 is limited, the case can be considered where original image information of the memory card M 130 is not copied to the information terminal A 100 but only summary image information is copied to the image information table 103. In this case, the original image information 1612, 1622, 1632, and 1642 shown in FIG. 16 is information equivalent to a blank. In addition, similar to the case where the original image information 1612, 1622, 1632, and 1642 is deleted from the image information table 103 in the state in FIG. 16, each item in the image information table 103 is information equivalent to a blank. In the present invention, it is possible to perform each process from step S1506 to 1512 even in this case. Generally, the capacity of a storage device required for storing summary image information is smaller compared to the capacity required for storing original image information. Therefore, in this way, the capacity of a storage device required in the information terminal A 100 may be small by not storing a part or all of the original image information by the information terminal A 100. However, according to the present invention, as is shown in FIG. 20 to FIG. 23, managing image information stored in a plurality of memory cards becomes easy, the same as the case where the user A stores all original image information in an information terminal. In the present invention, even in the case where there is no original image information of images stored by the memory card M 130 in the image information table 103 of the information terminal A, card NIDm of the memory card M 130 is correlated with the an original image ID and stored in the image attribute table 104. Therefore, by displaying card additional information of the memory card M 130 which is an original storage destination of an image for which there is no original image information in the information terminal A on the display means 107, it is possible to encourage user A to connect the memory card M 130 to the information terminal A 100.

Next, again referring to FIG. 20, the user A move the cursors 2002 by operating the input means 106 of the information terminal A 100 and selects summary images 2011, 2013, and 2016. The user A then moves the cursor 2002 and selects a storage service X display part 2024 (step S2402). This operation by user A corresponds to providing an instruction to the information terminal A 100 to copy an original image corresponding to the selected summary image to the storage service X.

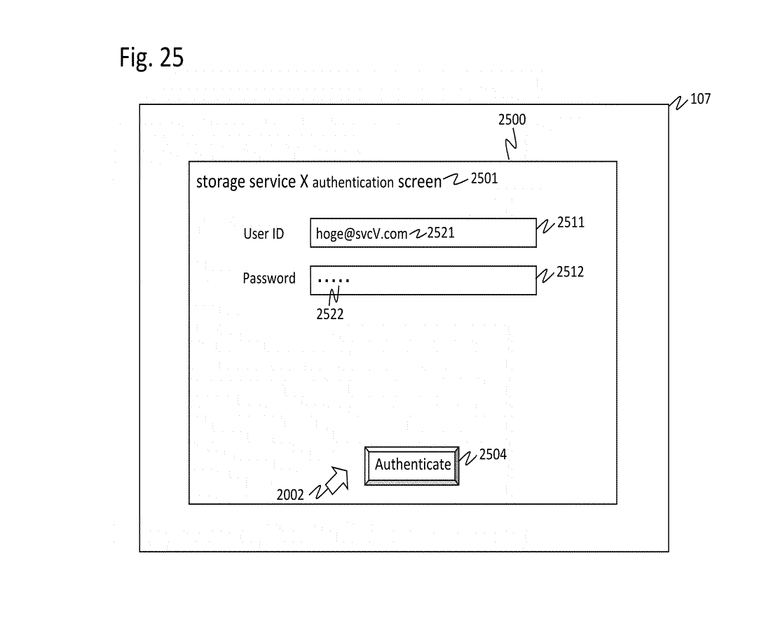

Next, the network sending and receiving means 101 of the information terminal A 100 sends a usage request of the storage service X by the user A to the server X 120 via the network 199. When the sending and receiving means 121 of the server X 120 receives this request, the HTML generation means 122 generates an HTML code for displaying an authentication screen, and the sending and receiving means 121 sends the code to the information terminal A 100 via network 199. In the information terminal A 100, when the network sending and receiving means 101 receives the code, the display means 107 displays the authentication screen of the storage service X120 after analysis by the HTML analysis means 111. An example of an authentication screen of the storage service X 120 is shown in FIG. 25. Display means 107 includes a browser window 2500. Browser window 2500 includes a display 2501 for displaying that this is the authentication screen of the storage service X120, a user ID input part 2511, a password input part 2512, and an authentication button 2504. Next, the user A operates the input means 106 and inputs his/her user ID 2521 and password 2522 used for authentication of the storage service X120 to the information terminal A. Then network sending and receiving means 101 sends the input user ID and password to the server X120 via the network 199. When sending and receiving means 121 of the server X 120 receives this, the authentication means 123 searches the user table 126 using the received user ID of the user A as a search key. When confirmation or a match of the password correlated and stored in advance with the user ID of the user A in the user information table 126 and the password received from the information terminal A100 is detected, the authentication of the user A by the authentication means is completed (step S2403).

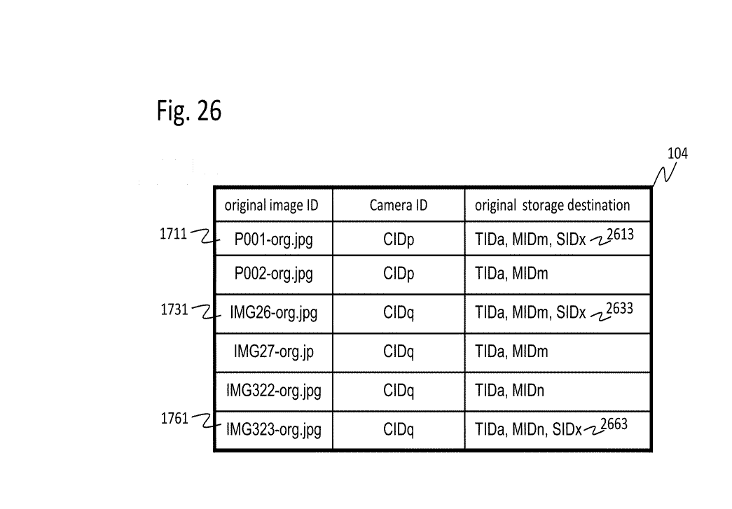

When the authentication of the user A by the server X120 is complete, the search means 110 of the information terminal A 100 searches for the original image IDs 1611, 1631, and 1661, and original image information 1612, 1632, and 1662 corresponding to summary images 2011, 2013, and 2016 selected in step S2402 from the image information table. Next, the network sending and receiving part 101 sends three sets of these original image IDs, original image information stored in the image information table and correlated with these original image IDs, and a camera ID stored in the image attribute table 104 to the server X120 via the network 199 (step S2404). In addition, the image attribute table 104 correlates and stores SIDx which is a service ID for uniquely identifying the storage service X120 with each original image ID 1711, 1731, and 1761 (step S2405). An example of information stored in the image attribute table 104 after step S2405 is executed is shown in FIG. 26. SIDx 2613, 2633, and 2663 are correlated and stored with original image IDs 1711, 1731, and 1761 respectively.

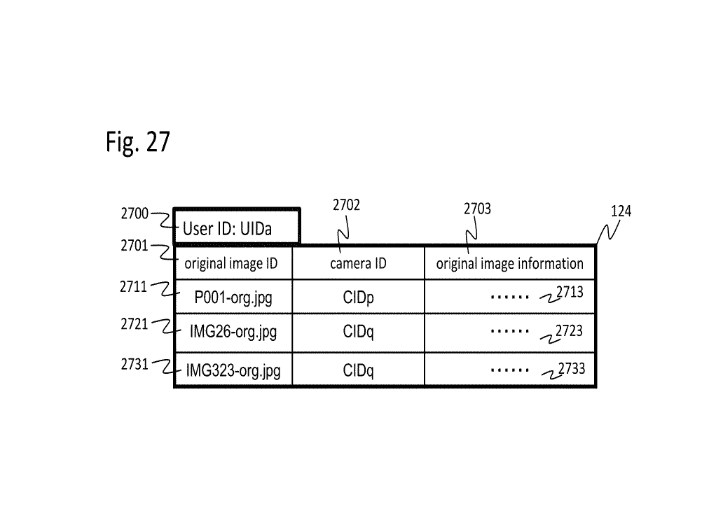

Next, the sending and receiving means 121 of the server X 120 receives original images sent from the information terminal A 100 in step S2404 and stored in the image information storage means 124 (step S2406). An example of the image information storage means 124 is shown in FIG. 27. The image information storage means 124 includes a user ID storage area 2700, a original image ID column 2701, a camera ID column 2702, and an original image information column 2703. In the present embodiment, it is explained that it is possible to uniquely identify original image information within the server X 120 using a combination of an original image ID and a camera ID. In the case where it is not possible to uniquely identify original image information using a combination of the original image ID and the camera ID, the image information storage means 124 may also be included with the global ID column described above.

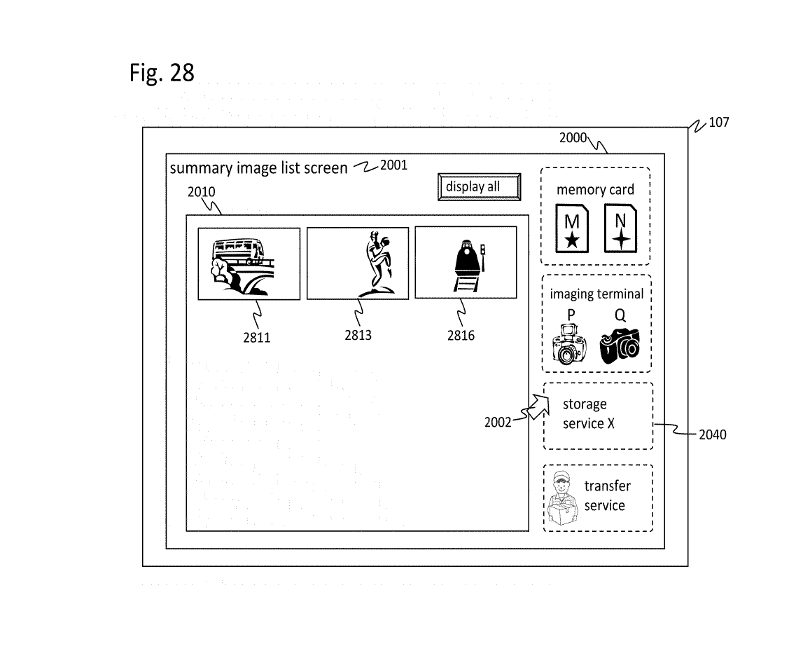

Via the processes in steps S2402 to S2406, the original image information 1612, 1632, and 1662 in FIG. 16 are stored in the image information storage means 124 of the server X 120. In this state, the user A operates the input means 106 of the information terminal A, moves the cursor 2002 displayed on the display means 107 and selects the display part 2040 corresponding to the storage service X 120 (step S2407). Then, the search means 110 searches the original storage destination column 1703 of the original image attribute table 104 using SIDx, which is a service ID of the storage service X 120, as a search key. The original image IDs 1711, 1731, and 1761 are obtained in the example in FIG. 26. These are original image IDs of original images stored in the storage service X 120 in addition to the information terminal A 100. Next, the search means 110 searches the image information table 103 using these original image IDs as search keys, and the search means 110 sends summary image information obtained as a result to the display means 107. The display means 107 displays the summary image information received here on the summary image display means 2010 (step S2408). In the example in FIG. 17, summary image information 1714, 1734, and 1764 are obtained as a search result and sent to the display means 107. As a result, the image displayed on the display means is shown in FIG. 28. Summary images 2811, 2813, and 2813 are displayed in the summary image display means 2010. These images show that the summary image information 1614, 1634, and 1664 in FIG. 16 are displayed. Via this operation, summary images of images stored in the storage service X 120 are selectively displayed in the summary image display means 2010. Here, although only one storage service is explained as an example, there may be a plurality of storage services such as a memory card or imaging terminal.

Now, storage capacity of the storage means in the information terminal A 100 is assumed to be insufficient for centralized management of these images. Thus, the user A may operate the input means 106 in order to delete a part or all of the original image information in the column 1602 of the image information table 103 shown in FIG. 16. Actually, among the information stored in the image information table 103, the image attribute table 104, the card additional information table 105 and the camera additional information table 109, the capacity of the original image information column 1602 is assumed to be the largest. Consequently, by deleting a part or all of the original image information in the column 1602, the possibility that the problem of insufficient storage capacity in the information terminal A can be resolved is high.

For example, it is assumed that the original image information 1652 has been deleted from the image information table 103. Although the original image information 1652 has been deleted from the image information table 103, the corresponding original image ID 1651, the summary image ID 1653, the summary image information 1654, the camera ID 1752, and the original storage destination 1753 are not deleted but stored in the information terminal A100. In addition, in the present invention, when original image information 1652 is deleted from the information terminal A 100, the original storage destination memory 1754 is deleted from the image attribute table 104. In this way, the information terminal A 100 can manage the fact that the summary image information which indicates the original image ID 1751 is stored not in the information terminal A 100 but only in the memory card N 135.

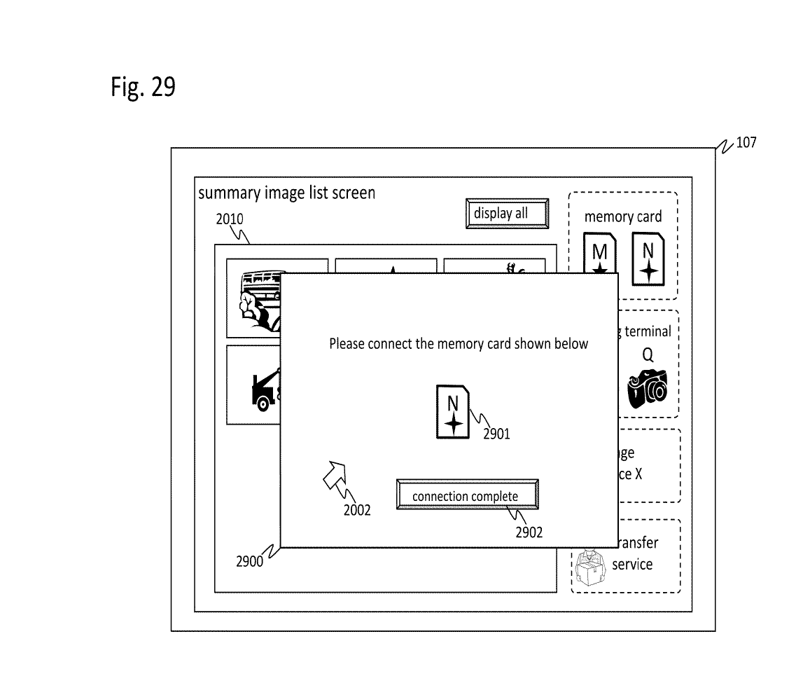

In this way, it is possible to carry out the process explained using in step S1506 to S1512 even in the state where original image information 1652 is removed from the information terminal A. In this state, the user A carries out the processes requiring the original image information 1652 in the information terminal A100 such as enlarging the display of an image in the display means 107, printing using the printing means 113, copying original image information to the memory card M 130, and copying original image information to the storage service X 120. Referring to FIG. 26, it is possible to specify a memory card or a storage service in which original image information is stored by searching the original storage destination column correlated and stored with a required original image ID. For example, in the case where the user A instructs the information terminal A 100 to enlarge the display of the image which indicates the original image ID 1651 using the input means 107, the search means 110 searches the image attribute table 104 using an original image ID, which indicates the original image information ID 1651, as a search key. As a result, the card ID 1753 of the memory card N 135 is obtained as an original storage destination. At this time, in order for the information terminal A 100 to obtain original image information, the display part 107 displays a connection request screen of the memory card N 135. An example of a connection request screen of the memory card N 135 is shown in FIG. 29. The connection request screen window 2900 includes an image 2901 of the memory card N 135, which becomes a storage destination, and a connection completion button 2902. The image 2901 of the memory card N135 displays the memory card additional information 1822 in the card additional information table 105.

As described above, an information terminal is provided arranged with an input and output part for inputting and outputting to and from an image storage device which stores image information taken by the imaging terminal, a storage part for associating and storing image identification information for identifying image information, summary image information having a smaller amount of information than the image information and device identification information for identifying the image storage device, and a display part as Embodiment one. An example of the operations of the information terminal is as follows. The device identification information stored in the storage part is displayed on the display part. In addition, the information terminal displays on the display part summary image information correlated with the device identification information selected from the device identification information displayed on the display part. Also, the information terminal displays image information on the display part correlated with the summary image information selected from the summary image information displayed on the display part.

In addition, a memory card is provided arranged with an image storage part for storing image information taken by the imaging terminal, and an input and output part which performs input and output with the information terminal and performs input and output to and from the imaging terminal which can connect to a network. An example of the operations of the memory card is as follows. The input and output part receives image information from the imaging terminal. The image information is stored in the image storage part. The input and output part correlates and sends memory card authentication information for uniquely identifying a memory card within a network and image information of the external appearance of the memory card with the image information to the information terminal.

In addition, a memory card is provided arranged with an image storage part for storing image information taken by the imaging device, and an input and output part which performs input and output with the information terminal and performs input and output to and from the imaging terminal which can connect to a network. An example of the operations of the memory card is as follows. The input and output part receives image information from the imaging terminal. The image information is stored in the image storage part. The input and output part correlates and sends memory card identification information for uniquely identifying a memory card within a network and image identification information for identifying image information with the image information to the information terminal.

In addition, a memory card is provided arranged with an image storage part for correlating and storing image information taken by the imaging device with summary image information having a smaller amount of information than image information, and an input and output part which performs input and output with the information terminal and performs input and output to and from the imaging terminal which can connect to a network. An example of the operations of the memory card is as follows. The input and output part receives image information and summary image information from the imaging terminal. The image storage part correlates and stores the image information and summary information with image identification information for identifying image information. The input and output part correlates and sends image information identification, memory card identification information for uniquely identifying a memory card within a network and image information of the external appearance of the memory card with the summary image information to the information terminal.

In an embodiment of the present invention, the user A can take images using a plurality of imaging terminals and manage in a unified manner all image information distributed and stored in storage services connected via a plurality of memory cards or a network even in the case where the information terminal A does not store the original image information. The reason for this is that in an embodiment of the present invention, the original image IDs 1701 of all images to be managed is correlated and stored with the storage destination 1703 of each original image in the image attribute table 104.

Next, the functions and effects related to the present invention are explained in detail using embodiment one described above. According to an information terminal, a memory card, an imaging terminal, a mobile terminal, a server, a method, and a system of the present invention, the following effects can be obtained.

The first effect in according to an embodiment of the present invention is that it is possible to collectively manage the image information taken by a plurality of imaging terminals using an information terminal A. According to the conventional method, because images taken by different imaging terminals are stored in different memory cards, these images are difficult to manage collectively. Conversely, attempting to collectively manage images by copying images taken by the imaging terminal to an information terminal such as a personal computer made it difficult to manage which images were taken by which imaging terminal. According to an embodiment of the present invention, for example, a user A has a camera ID for uniquely identifying each imaging terminal among a plurality of imaging terminals, and these are stored in the image attribute table 104 of the information terminal A 100 via a memory card (step S1501 and S1502). As is shown in FIG. 17, the image attribute table of the information terminal stores a correlation of each original image ID taken by the user A using a plurality of imaging terminals with the camera ID which is used to take an image. As a result, as is shown in FIG. 24, it is possible to display a list of images taken by a selected imaging terminal simply by the user A by selecting (step S1511) the imaging device on the display part (step S15112). For example, it is possible to make both a request wishing to collectively manage the still pictures taken with a still camera held by the user, images taken with a mobile phone, and video taken with a video camera, and a request wishing to extract only pictures taken with the mobile phone with a single click.

The second effect according to an embodiment of the present invention is that it is possible for a user to collectively manage original images stored and distributed across a plurality of memory cards. According to an embodiment of the present invention, a memory card includes a card ID for uniquely identifying the memory card. When image information taken by an imaging terminal is stored in the memory card, a card NID is generated by performing a calculation or conversion of the card ID by the imaging terminal and is stored in the a card NID storage means of the memory card. Following this, the card NID is stored in the image attribute table 104 of an information terminal when the memory card is connected to the information terminal (step S1501 and S1502). As is shown in FIG. 17, the image attribute table of an information terminal stores the correlation of an original image ID and card NID of a memory card. As a result, as is shown in FIG. 21 and FIG. 22, the user A can display a list of images taken by the selected imaging terminal just by selecting (step S1507 and S1509) the memory card on the display means (step S1508 and S1510). In the conventional method, it is not easy for a user who uses a plurality of memory cards to manage which memory card required original image information is to be stored in. On the other hand, according to an embodiment of the present invention, because it is possible to browse summary images of images stored in each memory card with one click, it is possible to easily find the intended original image information. According to the present invention, it is possible to manage image information in a unified manner without storing original image information in the information terminal A even in the case of an image stored by the information terminal A and even in the case where the image information is stored only in a memory card or storage service which improves usefulness.

A third effect according to an embodiment of the present invention is that intuitive management is possible since it is possible to distinguish a plurality of memory cards or plurality of imaging terminals using images representing each memory card or terminal when the user A manages images using the information terminal A. According to the conventional method, in the case of a memory card, it is difficult to specify or estimate the content and imaging date of an image stored just by external appearance. Although there is a method for a user to attach a label to a memory card, mechanical problems are often caused when a user inserts a memory card into the slot of the information terminal or the camera, which is not a method that is commonly used. According to the present invention, the server Z 180 includes a card additional information master table 191. Image information representing the appearance of each of a memory card is correlated with a card NID of the memory card and stored in advance in card additional information master table. The information terminal A sends a card NID, which is received from the imaging terminal P 140 and the imaging terminal Q 145 and stored in the card additional information master table to the server Z 180, and the card additional information is received from the server Z 180 (step S1504). The images 1821 and 1822 of the card additional information in FIG. 18(a) are received from the server Z and represent the external appearance of each memory cards M 130 and N 135. As a result, the user A can intuitively understand what type of original image information is stored in the memory card M 130 or the memory card N 135 by comparing the summary images 2021 and 2022 displayed on the summary image display part 2010 shown in FIG. 21 and FIG. 18 with the appearances of the memory card M 130 and memory card N 135. Similarly, in the present invention, image information representing the external appearance of each of a plurality of imaging terminals held by the user A for example, is stored in the camera additional information table 109 of the information terminal A via a memory card. Camera additional information which is an image representing the external appearance of each imaging terminal is, for example, displayed as image 2031 and 2032 in FIG. 20 on the display part 107. The images 2031 and 2032 of the camera additional information indicate the external appearances of the imaging terminal P 140 and the imaging terminal Q 145. As a result, the user A can intuitively understand what type of imaging terminal each original image information is taken by comparing the summary image displayed on the summary image display part 2010 shown in FIG. 23 with the image 2031. In the present embodiment, camera additional information is stored in each imaging terminal and copied to the information terminal A 100. However, similar to the card additional information described above, by providing a table storing the corresponding relationship of a camera ID and camera additional information in the server Z 180 and sending the camera ID to the server Z 180 by the information terminal A, the information terminal A may obtain the camera additional information from the server Z 180 and store it in the camera additional information table.

The fourth effect according to an embodiment of the present invention is that it is possible to collectively use a memory card and a storage service without being aware of the difference between the memory card and the storage service connected to the memory card and a network. In the explanation of the present embodiment, an image selected in step S2402 is stored in the server 120 of the storage service X via a network. At this time, in the image attribute table 104 of the information terminal A 100, as shown in FIG. 26, the ID of the storage service X in addition to the card ID is correlated and stored with an original image ID of an original image in the storage service X as an original storage destination. As a result, the user A can easily browse a list of images stored in the storage service X using the information terminal A 100 just by selecting the storage service X displayed on the summary image list screen. According to the present invention, a user can uniformly treat original images stored in an arbitrary server connected to information terminal A 100 via a network in addition to an original image stored in a plurality of memory cards.

A fifth effect according to an embodiment of the present invention is that it is not necessary for the user A to store all original images. As described above, in an embodiment of the present invention, all original images taken by a plurality of imaging terminals and stored in a plurality of memory cards or a storage service via a network can be centrally managed with the information terminal A 100. According to the conventional method, in order to centrally manage image information using the information terminal A 100, it is necessary to store original image information of all original images in the information terminal A 100. In an embodiment of the present invention, as shown in FIG. 26, this effect arises because a correlation of a card ID or a storage service ID that indicates an original image ID and the storage location is stored in the image attribute table 104 of the information terminal A 100.

A sixth effect of the present invention is that the first to the fifth effects described above are effective even in the situation where a card ID uniquely specifying a memory card cannot be read by an information terminal. An SD card is the most generally device used for connecting to an imaging terminal and for storing image information. Most SD cards are in a state where information which can uniquely specify the SD card such as a manufacturer, a manufacture information, a serial number, or the like is not deleted even if the card is formatted. However, most personal computers which are an example of an information terminal recognize an SD card as a USB (Universal Serial Bus) Mass storage. As a result, an ID for uniquely specifying an SD card often cannot be read from a usual personal computer. According to the present invention, even in this case, after the imaging terminal P 140 and the imaging terminal Q 145 generated a card NID, this is sent to the card NID storage means 134 and 139. By storing in an area within an SD card from which the card NID can be read via a USB, the first to fifth effects described above related to the present invention can also be obtained by a user of an SD card.

### Second Embodiment

In the second embodiment of the present invention, a user A passes a memory card N to a user B and a user B connects the memory card to a display terminal B. In this state, the user A can copy arbitrary original image information to the memory card N using the information terminal A. Then, the original image information is sent to the memory card N connected to the display terminal B via an information terminal A 100, a display terminal B 150 and an network 199, and stored here. The card NID of the memory card N is used as transfer destination information of the image information during transfer of the original image information via the network.

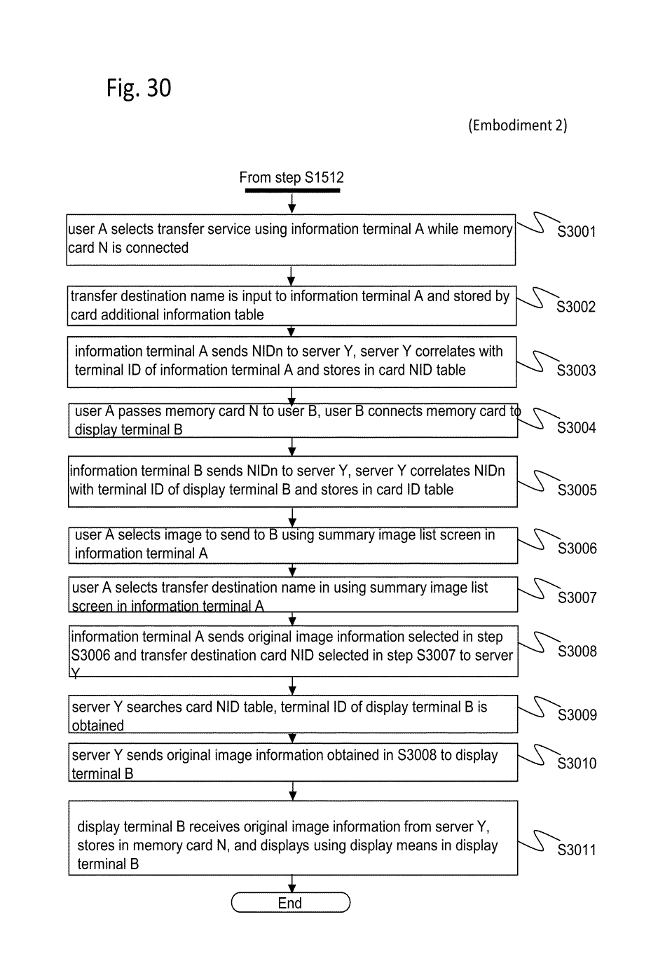

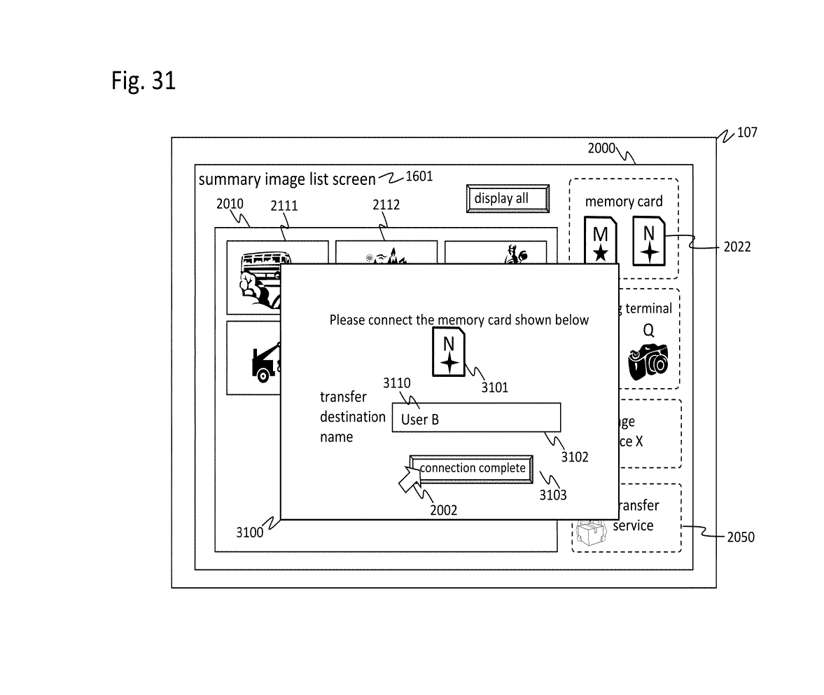

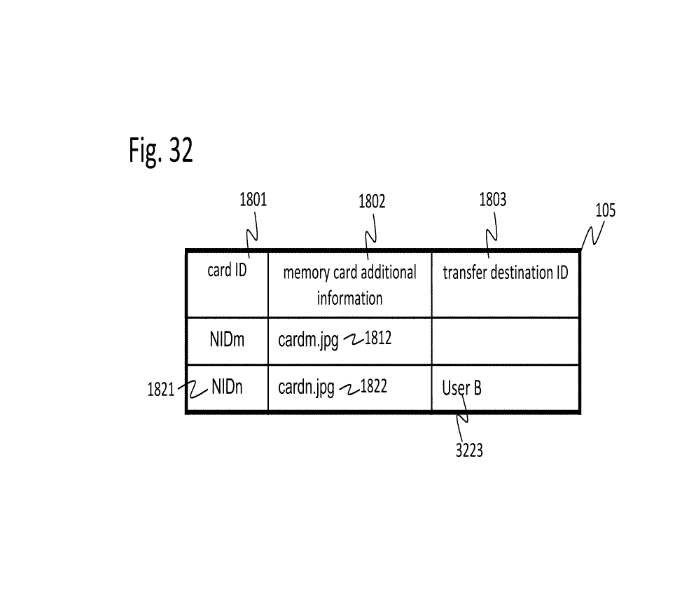

The second embodiment is explained using the flowchart shown in FIG. 30. The user A selects the transfer service display part 2050 in the summary image list screen shown in FIG. 20 with the memory card N 135 connected to the information terminal A 100 (step S3001). Then, a transfer destination input screen is displayed on the display part 107. An example of the transfer destination input screen is shown in FIG. 31. A window 3100 of the transfer destination entry screen includes image 3101 of the memory card N, a transfer destination name input section 3102 and a completion button 3103. Image 3101 of the memory card N 135 is generated from the memory card additional information 1822 stored in the card additional information table 105. Here, the user A inputs the name of a user B 3110 (transfer destination name), who is a partner to pass the memory card N135 to, in the transfer destination name input section 3102 by operating the input means 106, and then selects the complete button 3103. The transfer destination name 3110 input by the user A here is stored in the transfer destination name column 1803 of the card additional information table 105 (step S3002). The card additional information table after step S3002 is executed is shown in FIG. 32. The name 3110 of the user B input in the transfer destination input screen is correlated and stored with the card NID 1821 of the memory card N 135 as a transfer destination name 3223 in the card additional information table.

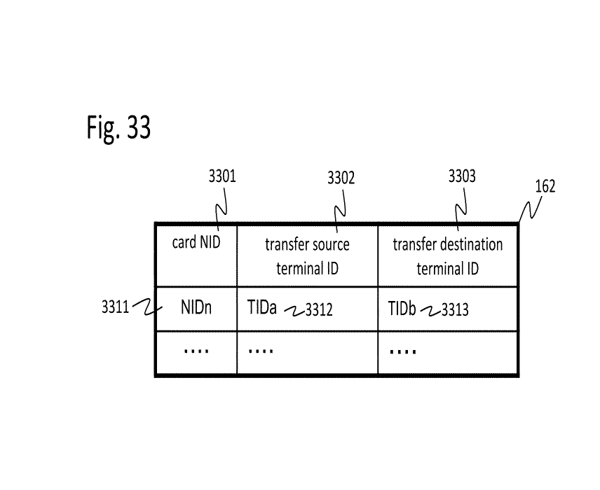

In addition, the network sending and receiving means 101 of the information terminal A sends the card NID 1821 of the card additional information table to the server Y 160 via the network 199. When the sending and receiving means 161 of the server Y receives this, the card NID 1821 is correlated and stored with the terminal ID for uniquely identifying the information terminal A 100 within the network 199 in the card NID table 162 (step S3003). An example of a card NID table 162 of the server Y 160 is shown in FIG. 33. The card NID table 162 includes a card NID column 3301, a transfer source terminal ID column 3302 and a transfer destination terminal ID column 3303. Via step S3003, a card NID 3311 received from the information terminal A 100 is correlated and stored with TIDa 3312, which is a terminal ID of the information terminal A100 obtained from a terminal ID management means 163. At the time of executing step S3003, the transfer destination ID 3313 is not stored in the card ID table of the server Y but in the a later step S3005.

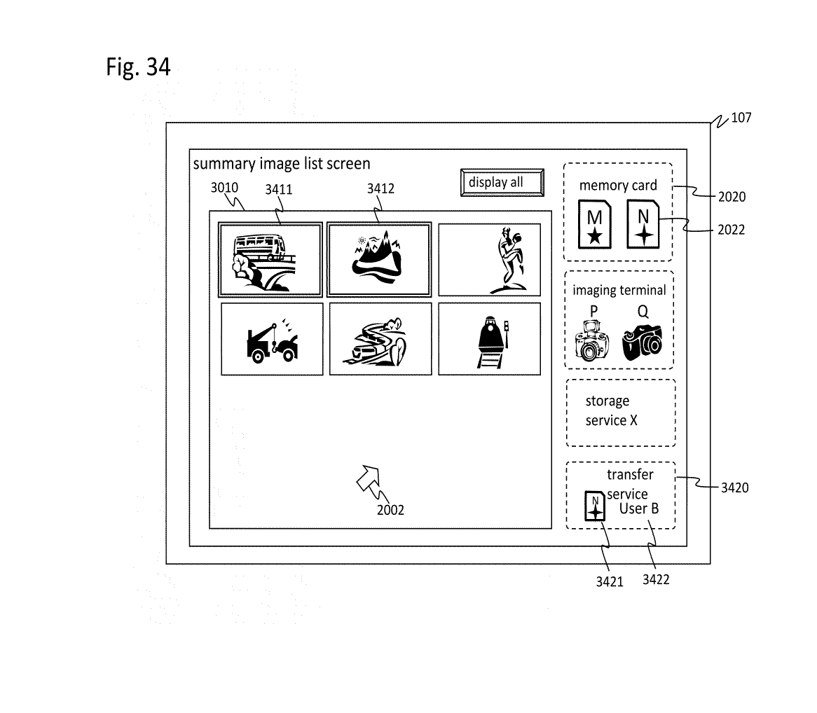

In addition, after step S3003 is executed, the display means 107 of the information terminal A displays a summary image list screen. An example of the summary image list screen after step S3003 is shown in FIG. 34. The transfer destination name 3422 input by user A in step S3002 is displayed in the transfer service display part 3420. As in the example shown in FIG. 34, a memory card additional information display 3421 of the memory card N135 may also be included.

Next, the user A removes from the memory card N 135 from the information terminal and passes or sends the card to the user B (step S3004). The user B, who receives the memory card N 135, connects the card to the display terminal B150. The card NID storage means 139 of the memory card N 135 sends NIDn, which is a card ID of the memory card N 135, to the display terminal B 150 via the input and output means 136. In the display terminal B, after the memory card input and output means 152 receives this, the network sending and receiving means 151 sends NIDn to the server Y160 via the network 199. The sending and receiving means 161 of the server Y receives NIDn, which is a card ID of the memory card N 135, from the display terminal B. Next, the search means of the server Y searches the card NID table 162 using the received NIDn as a search key. Again referring to FIG. 33, as a result the card NIDn3311 is detected. Then, the card NID table correlates TIDb, which is a terminal ID for uniquely identifying the display terminal B which is the sending source of NIDn in the network 199, with NIDn3311 after acquiring from the terminal ID management means 163, and stores in the transfer destination terminal ID column 3303 of the card NID table 162 (step S3005). TIDb3313 in FIG. 33 is stored in the card NID table 162 when step S3005 is executed and the card NID table 162 becomes the state shown in FIG. 33.

Next, in a state where the summary image list screen shown in FIG. 34 is displayed, the user A operates the input means 106 the display part 107 of the information terminal A, moving the cursor 2002 and selects the summary image to be transferred to the user B (step S3006). FIG. 34 shows the state of the selected summary image 3411 and 3412 by user A. In the example shown in FIG. 34, the double line around the summary image indicates that it is selected. Next, the user A moves the cursor 2002 by operating the input means 106, and selects the transfer destination name 3422 displayed in the display means 107 or the image 3421 of the memory card N 135 (step S3007). This series of operations in step S3006 and 3007 are processes for transferring an arbitrary image to the user B who has the memory card N135 at this time by the user A using a transfer service.

Next, the search means 110 of the information terminal A obtains original image information 1612 and 1622 which indicate the summary images 3411 and 3412 selected in step S3006 from the image information table 103. In addition, the search means 110 obtains the card NID 1821 correlated and stored in the card additional information table 105 which indicates the transfer destination name 3422 selected in step S3007. Next, the sending and receiving means 101 of the information terminal A sends the original image information 1612 and 1622 obtained here and sends card NID 1821 to the server Y 160 via the network 199 (step S3008). When the sending and receiving means 161 of the server Y 160 receives this, the search means 164 searches the card NID table 162 using the card ID1821 received from the information terminal A as a search key. Referring again to FIG. 33, the transfer destination terminal ID3313 correlated and stored with the card NID 3311 is obtained (step S3009). Next, the sending and receiving means 161 of the server Y160 sends the original image information 1612 and 1622 sent from the information terminal A 100 in step S3008 to the display terminal B 150 via the network 199 with the transfer destination address ID3313 (step S3010).

The network sending and receiving means 151 of the display terminal B 150 receives the original image information 1612 and 1622 from the server Y160. Next, the memory card input and output means 152 sends this original image information to the connected memory card N 135. When the input and output means 136 of the memory card N 135 receives the original image information, it is stored in the image storage means 137. In addition, the display means 153 of the display terminal B displays the original image information 1612 and 1622 received from the server Y160 (step S3011).

As described above, the user A sends an image to the display terminal of the user B using the card ID of the memory card N 135 stored in the information terminal of the user A and the display process is complete. Furthermore, in the explanation of the present embodiment, the information terminal A 100 in step S3008 sent original image information taken in step S1001 in the explanation of the first embodiment to the display terminal B 150 via the server Y 160. That is, in the present embodiment, before the user A specifies the transfer destination in step S3002, original image information stored in the information terminal A is sent to the information terminal B. However, in the present invention, after the transfer destination is specified by the user A, the user A takes an original image using an imaging terminal, and may send original image information stored in the image information table of the information terminal A via the memory card to the display terminal B via the process in step S3004 below. In this way, after the user A has passed the memory card N 135 once to the user B, the user B can obtain the original image information through the network 199 just by the user A operating the information terminal A.

In the second embodiment of the present invention, it is possible to remove a memory card and utilize the property of the memory card that it can be connected to an information terminal of another user. In the second embodiment, the memory card N 135 is passed to the user B from the user A, and while being connected to the display terminal B 150, the card NID management table 162 of the server Y 160 correlates and stores the card NID 3311 of the memory card N with the transfer destination ID 3313 for uniquely identifying the display terminal of the user B within the network. That is, in the second embodiment, in addition to the card NID explained in the first embodiment, it is possible for the user A to uniformly and easily send their own original image information to the user B using the ID for uniquely specifying a display terminal.

In the first embodiment, even when original image information is deleted from the image information table 103 of the information terminal A, the information terminal A stores a correlation of summary image information and an original image ID. Consequently, the information terminal A is able to prompt the user A to obtain an original image using the screen shown in FIG. 29. For example, in the second embodiment, in a state where the memory card N 135 is connected to a display terminal B 150 of the user B, the user A attempts to send original image information which is not stored in the information terminal A 100 but is stored in the memory card M 130 to the user B. In addition, in this case the original storage destination column 1703 of the image attribute table 104 is searched using the selected original image ID as a search key. A connection request to the memory card is made to the user A based on the card NID of the memory card M130 obtained as a result. In this way, it is possible to send original image information to the user B using the method of the present embodiment even if the original image information is stored in the information terminal A 100, an arbitrary memory card, or an arbitrary storage service.

A system including a first information terminal, a second information terminal, and a server is provided as the second embodiment as described above. In this system, the first information terminal is arranged with an input and output part for inputting and outputting with an image storage terminal which stores image information taken by an imaging terminal, a storage part which correlates and stores image identification information for identifying image information, summary image information having less information than image information, and device identification information for identifying an image storage device, a network sending and receiving part for communicating with a server, and a display part. In addition, in this system, the second information terminal is arranged with an input and output part for inputting and outputting with an image storage device, and a network sending and receiving part for communicating with a server. Furthermore, in this system, the server device is arranged with a network sending and receiving part which communicates with the first information terminal and the second information terminal first respectively, and a storage part.

An example of the operation of this system is as follows. A display part of the first information terminal displays device identification information. In addition, the display part of the first information terminal displays summary image information. Furthermore, the network sending and receiving part of the first information terminal sends image information correlated with summary image information selected from the summary image information displayed on the display part of the first information terminal, and the displayed device identification information to the server. In addition, the network sending and receiving part of the server receives the image information and device identification information from the first information terminal. The storage part of the server correlates and stores image information received by the network sending and receiving part of the server with the device identification information. In addition, input and output part of the second information terminal obtains the device identification information of the image storage device. The network sending and receiving means of the second information terminal sends the device identification information obtained by the input and output part of the second information terminal. In addition, the network sending and receiving part of the server receives the device identification information from the second information terminal and sends the image information correlated and stored with the received device identification information to the second information terminal. In addition, the network sending and receiving part of the second information terminal receives the image information from the server. Furthermore, the input and output part of the second information terminal stores the image information received from the server in the image storage device.

In addition, a memory card is provided arranged with an image storage part for storing image information taken by an imaging terminal, and an input and output part which inputs and outputs with an imaging terminal and inputs and outputs with the first information terminal which can connect to a network and the second information terminal which can connect to a network. An example of the operation of the memory card is as follows. The input and output part receives first image information from an imaging terminal. The first image information is stored in the image storage part. The input and output part correlates memory card identification information for uniquely identifying a memory card in the network with image information of the external appearance of the memory card and sends this to the first information terminal. The input and output part connected to the second information terminal sends the memory card identification information to the second information terminal. When the second image information and image information of the external appearance of the memory card is selected on the display part of the first information terminal, the second image information is received via the network and second information terminal using memory card identification information as a key. The second image information received from the second information terminal is stored.

Next, the effects of the embodiments of the present invention are explained using the second embodiment in addition to the six effects explained in the first embodiment.

The seventh effect according to an embodiment of the present invention is that it is possible for the user A to show a photograph to the user B if the user A passes a memory card N once to the user B without the user A subsequently using the memory card N. In the conventional method, after the user A has copied an original image to memory card N using the information terminal A and passed the card to the user B, in the case where original image information is again copied to the memory card N from the information terminal A, it is necessary to obtain the memory card N from the user B, copy additional original image information to the memory card N and again pass the memory card N to the user B. Therefore, it is necessary to physically exchange a memory card in order to exchange original image information between two parties using a memory card as the medium in the conventional method. In the method according to the present invention, after the user A copies the original image to the memory card N using the information terminal A and passes the card to the user B, it is possible to send the original image from the user A to the memory card held by the user B without having to physically exchange a memory card.

The eighth effect according to an embodiment of the present invention is that it is possible for the user A, who manages original images and summary images on an information terminal using the present invention, to realize transfer of original image information to other users or other terminals using a unified operation. Conventionally, in the case when the user A sends original image information via a network to the user B, there is a method of sending by attaching to an e-mail, or a method of uploading to a storage service or a method of notifying user B of a URL specifying the uploaded image. In this case, first it is necessary for the user A to determine in which memory card, information terminal, or storage service an image to be sent to the user B is stored. Furthermore, it was necessary to input a mail address and send an e-mail to the user B or notify the user B of the upload destination after obtaining the URL. According to the present invention, it is possible for the user A to send an original image to the display terminal of the user B by using the same operation for copying original image information to the user A's own memory card or a storage service used by the user A. In this way, it has become easier to send photographs to family or a friend who has a photo frame product, a TV, a camera, a computer, or a mobile phone that can be connected to a network by providing a memory card slot. In addition, in the method of the present invention, original image information may also be sent to a photo frame product, a television, a camera, a computer, or a mobile phone held by the user A which can be connected to a network by providing a memory card slot. For example, original image information taken by multiple cameras may be managed, using a plurality of memory cards or storage services, on a computer corresponding to the information terminal A, and a part of this may be browsed on a digital photo frame product, TV, a camera, a computer, or a mobile phone held by the user A.

### Third Embodiment

In the first embodiment of the present invention, the processes shown in the flow chart in FIG. 10 is executed using original image information and summary image information stored in the image information table 103, and an original storage destination stored in the image attribute table 104. In the third embodiment of the present invention explained below, a correlation between original image information, summary image information, and original storage destination is stored in the server Z 180 of an image management service. In this way, the user A can take a plurality of images using a plurality of imaging terminals and collectively execute image management the same as in the first embodiment of all images storing original image information in a plurality of memory cards or storage services through the web browser of the mobile terminal 170.

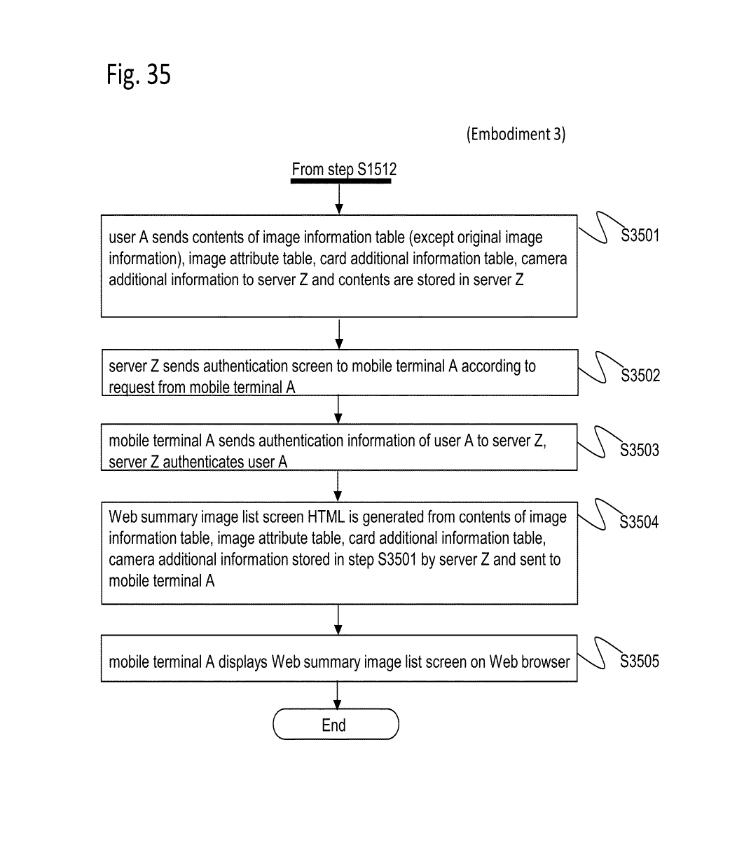

The present embodiment is explained using the flowchart shown in FIG. 35. First, the network sending and receiving means 101 of the information terminal A170 sends original image ID column 1601, summary image ID column 1703, and summary image information column 1704 of the image information table 103 to the server Z 180 via the network 199. When sending and receiving means 181 of the server Z 180 receives these, they are stored in the summary image information table 187. Summary image information table 187 of the server Z 180 is the same as the image information table 103 of the information terminal A but does not include the original image information column 1602. Similarly, network sending and receiving means 101 of the information terminal A170 sends the information of the image attribute table 104 to the server Z 180 via the network 199. When sending and receiving means 181 of server Z 180 receives this, it is stored in the image attribute table 188. Furthermore, similarly the entire contents of the card additional information table 105 of information terminal A 170 is copied to the card additional information table 189 of server Z180, or the entire information of the camera additional information table 109 of the information terminal A 170 is copied to card additional information table 190 of server Z 180 respectively (step S3501).

Next, when the user A operates the input means of the mobile terminal A 170, the network sending and receiving means 171 sends an authentication request screen of image management service Z through the network 199 to the server Z 180. When the sending and receiving means 181 of the server Z180 receives this, the HTML generation means 182 generates an HTML code for drawing an authentication screen of the image management service Z, and the sending and receiving means 181 sends the code to the mobile terminal A 170 through network 199 (step S3502). When the network sending and receiving part 171 of the mobile terminal A 170 receives this code, the HTML analysis part 173 analyzes the result, and the display means 174 displays the authentication screen of the image management service Z. Here, the authentication screen is comprised from a user ID input field and a password input field in the image management service Z. However, any information input screen means may be used as long as the user A can be authenticated. Next, the user A operates the input means 172 and inputs a user ID and a password of the user A in the image management service Z, and the network sending and receiving means 171 sends this information to the server Z 180 through the network 199. When the sending and receiving means 181 of the server Z 180 receives this information, the user A is confirmed by the authentication means 183 when a confirmation or match of the user ID and password of user A stored in the user information table 186 is detected (step S3503).

Next, the HTML generation means 182 of the server Z reads the summary image stored in the summary image information table 187, the memory card additional information stored in the card additional information table 189 and the camera additional information stored in the camera additional information table 190 and generates an HTML code necessary to generate a Web summary image list screen. Next, the sending and receiving means 181 sends the HTML code to the mobile terminal 170 via a network (step S3504). When the network sending and receiving means 171 of the mobile terminal receives this HTML code, the code is analyzed by the HTML analysis means 173 and the display means 174 displays the Web summary image list screen (step S3505).

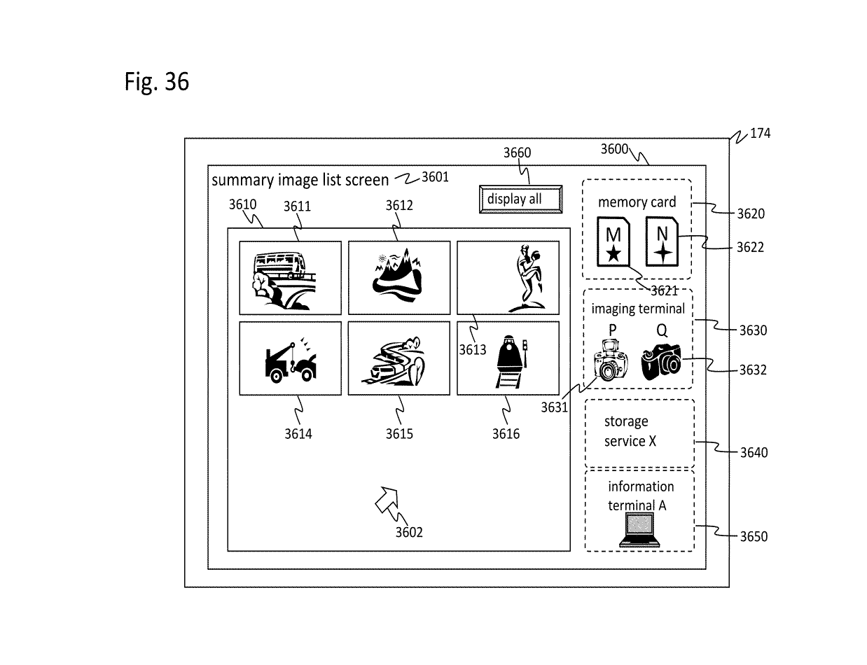

An example of a Web summary list screen image is shown in FIG. 36. The display means 174 of the mobile terminal A includes a Web browser window 3600. The web browser window 3600 includes a display 3601 which shows that this is a Web summary image list screen, a summary image display part 3610, a memory card display part 3620, an imaging terminal display part 3630, a storage service X display part 3640, an information terminal A display part 3650 and a button 3660 for displaying all. In the example shown in FIG. 36 the summary images 3611 to 3616 are displayed on the summary image display part 3610. These summary images show that the summary images stored in the summary image information table 187 of the server Z are sent via the network 199 to the mobile terminal A170 as an HTML code. The memory card image 3621 of the memory card M 130 and the memory card image 3622 of the memory card N 135 are displayed in the memory card display part 3620. These images show that memory card additional information stored in the card additional information table 189 is displayed by the display part 174. In addition, image 3631 of the imaging terminal P 140 and image 3632 of the imaging terminal Q 145 are displayed in the imaging terminal display part 3630. These images show that the camera additional information stored in the card additional information table 190 of the server Z 180 is displayed by the display part 174. The Web summary image list screen shown as an example in FIG. 36 is similar to the summary image list screen shown in FIG. 20. FIG. 20 of the first embodiment explained that information stored in the image information table 103, the image attribute table 104, the card additional information table 105 and the camera additional information table 109 of the information terminal A100 is displayed on the display means of the information terminal A100. FIG. 36 of the present embodiment shows that information stored in the summary image information table 187 of the server Z 180, the image attribute table 188, the card additional information table 189 and the camera additional information table 190 is obtained by the mobile terminal A170 via the network 199 as an HTML code and displayed by the display means 174. In the example shown in FIG. 36, the display within the Web browser window 3200 is set to be the same as that shown in FIG. 20. However, as long as a summary image display part 3210 is included, other screen elements other may be included or omitted.

In this state, the user A can display on the summary image display part 3610 the same as in the first embodiment, a summary image list of images in which original image information is stored by selecting each part of the memory card M 3621, the memory card N 3622, the imaging terminal P 3631, the imaging terminal Q 3632, and the storage service X 3640. Because this operation by the user A is the same as in step S1501 to step S1512 shown in FIG. 15, an explanation is omitted here. In addition, the user A operates the input part 172 of the mobile terminal A, moves the cursor 3602, and when the user A selects the display part 3650 of the information terminal A in FIG. 36, among the summary images stored in the summary image information table 187 of the server Z 180, only a summary image for which an original image is stored in the image information table 103 of the information terminal A is selectively displayed on the Web browser 3600. Furthermore, copying original image information among the information terminal A, the memory card M, the memory card N, and server X can also be executed by a Web browser window of the mobile terminal A using the same method as explained in the first embodiment.

As described above, in the present embodiment, a system is provided including an information terminal, a mobile information terminal, a first server, and a second server. In this system, an information terminal is arranged with a first input and output part which inputs and outputs with an image storage device which stores image information taken by an imaging terminal, a storage part which correlates and stores image identification information for identifying image information, summary image information with a smaller amount of information than image information, and device identification information for identifying the image storage device, and a network sending and receiving part for communicating with the server. In addition, in this system, the first server and the second server are arranged with a network sending and receiving part for communicating with the information terminal and the mobile information terminal, and a storage part respectively.

An example of the operation of this system is as follows. The network sending and receiving means sends image identification information, summary image information, and device identification information stored in the storage part of an information terminal, and the network sending and receiving part of the first server receives the image identification information, summary image information and device identification information from the information terminal. The storage part of the first server stores the image identification information, summary image information, and device identification information received by the network sending and receiving part of the server. The network sending and receiving part of the information terminal sends the image information and the image identification information stored in the image storage device. The network sending and receiving part of the second server receives the image information and image identification information from the information terminal. The storage part of the second server stores the image information and image identification information received by the network sending and receiving part of the second server. The network sending and receiving part of the first server receives the device identification information sent from the mobile terminal. The network sending and receiving part of the first server sends the summary image information and image identification information correlated and stored with the received device identification information to the mobile terminal. The network sending and receiving part of the second server receives the image identification information sent from the mobile terminal, and the network sending and receiving part of the second server sends the image information correlated and stored with the received image identification information to the mobile terminal.

In addition, in the present embodiment, a server is provided arranged with a first information terminal and second information terminal which include an input and output part for inputting and outputting with an image storage device which stores image information taken by an imaging terminal, a network input and output part for connecting via a network, and a storage part which correlates and stores image identification information for identifying image information, summary image information with a smaller amount of information than the image information, and device identification information for identifying an image storage device. An example of the operation of the server is as follows. The network input and output part receives image identification information, summary image information and device identification information from the first information terminal. The storage part correlates and stores the image identification information, summary image information and device identification information. The summary image information and image identification information are sent to the second information terminal. The summary image information and image identification information selected by the second information terminal is received. The device identification information correlated and stored with the image identification information is sent to the first information terminal. The image information is received via the first information terminal from the image storage device and is sent to the second information terminal.

Next, the effects of the present invention obtained by using the third embodiment are explained in addition to the eight effects explained in the first and second embodiments

The ninth effect according to an embodiment of the present invention is that it is possible to perform the same operations as the first embodiment and second embodiment via a Web browser by correlating a summary image and an original storage destination with each original image ID and storing in the server Z 180 in advance regardless of the storage destination of the original image. In particular, the capacity of the storage part of a mobile terminal is often small in comparison with a server or a stationary type information terminal. In the conventional method, in order to carry out the processes in the mobile terminal using the same method as in the first embodiment and second embodiment, it is necessary to take images using a plurality of imaging terminals, and store all the original image information stored in a plurality of memory cards or storage services in the storage means of the mobile terminal, which in most cases is not practical. In the present invention, it is possible to realize the same operations as in the first and second embodiments with respect to taking images using a plurality of imaging terminals and all of the original image information stored in a plurality of memory cards or storage services can be accessed using a Web browser without storing the original image information in a mobile terminal.

The tenth effect of an embodiment according to the present invention is that it is possible to conserve storage capacity of the server Z since the original image information is not stored in the summary image information table 187 of the server Z. In the conventional method, a summary display list screen is generated from the mobile terminal A by storing all original images in a Web server. However, in this method, because all original image information is stored in the storage of a Web server, storage capacity and costs are increased. On the other hand, in the method according to the present invention, because the server Z stores summary image information but does not store original image information, storage capacity required by the server Z is greatly reduced compared to conventional methods. It is possible to realize the same operations as in the first and second embodiments with respect to taking summary image ID's and summary image information using a plurality of imaging terminals and all of the original image information stored in a plurality of memory cards or storage services.

According to the present invention, it is possible to maintain and manage in a unified manner a large amount of image information taken by one user using a plurality of imaging terminals and distributed and stored across a plurality of memory cards, information terminals and servers using an information terminal and Web browser, send arbitrary images easily to another person and browse the image on a display terminal or mobile terminal.

What is claimed is:

1. A memory card configured to execute steps of:
sending first memory card identification information from a first memory card identification storage part for the storing the first memory card identification information to a first imaging terminal;
receiving a first calculation result of a calculation performed on the first memory card identification information by the first imaging terminal from the first imaging terminal;
storing the first calculation result as second memory card identification information into a second memory card identification information storage part;
receiving first image information taken by the first imaging terminal and first image identification information for specifying the first image information from the first imaging terminal;
sending the second memory card identification information and the first image identification information, in a state where the second memory card identification information and the first image identification information are correlated, to an information terminal;
sending the first memory card identification information to a second imaging terminal;
receiving a second calculation result of a calculation performed on the first memory card identification information by the second imaging terminal from the second imaging terminal;
storing the second calculation result as third memory card identification information into the second memory card identification information storage part;
receiving second image information and second image identification information for specifying the second image information from the second imaging terminal; and
sending the third memory card identification information and the second image identification information, in a state where the third memory card identification information and the second image identification information are correlated, to the information terminal.

2. The memory card according to claim 1, wherein the first memory card identification information stored in the first memory card identification information storage part cannot be read by the information terminal.

3. An imaging terminal configured to execute steps of:
receiving first memory card identification information for identifying a first memory card from the first memory card;
sending a result of performing a calculation on the first memory card identification information as second memory card identification information, which can uniquely identify the first memory card within a network communicating via an information terminal connected with the first memory card, to the first memory card;
receiving third memory card identification information for identifying a second memory card from the second memory card; and
sending the result of performing a calculation on the third memory card identification information as fourth memory card identification information which can uniquely identify the second memory card, within the network communicating via the information terminal connected with the second memory card, to the second memory card.

4. An information terminal including a display means for displaying an image information display part, the terminal being configured to execute steps of:
receiving a result of performing a calculation on first memory card identification information by an imaging terminal as second memory card identification information, which can uniquely specify a first memory card within a network connected to the information terminal, the first memory card identification information being stored in a first memory card identification information storage part of the first memory card;
receiving first image information taken by the imaging terminal and first image identification information for identifying the first image information from the first memory card;
correlating and storing the second memory card identification information with the first image information and the first image identification information;
receiving a result of performing a calculation on third memory card identification information by the imaging terminal as fourth memory card identification information, which can uniquely specify a second memory card within a network connected to the information terminal, the third memory card identification information being stored in a second memory card identification information storage part of the second memory card;
receiving second image information taken by the imaging terminal and second image identification information for identifying the second image information from the second memory card; and
correlating and storing the fourth memory card identification information with the second image information and the second image identification information.

5. An information terminal including a display means for displaying an image information display part, the terminal being configured to executed steps of:
receiving, from a first memory card, a result of performing a calculation on first memory card identification information by an imaging terminal as second memory card identification information, which can identify the first memory card, the first memory card identification card identification information being stored in a first memory card identification information storage part of the first memory card;
receiving, from the first memory cared, first image information taken by the imaging terminal and first image identification information for identifying the first image information;
correlating and storing the second memory card identification information with the first image information and the first image identification information;
receiving, from a second memory cared, a result of calculating third memory card identification information by the imaging terminal as fourth memory card identification information for identifying the second memory card, the third memory card identification information being stored in the second memory card identification information storage part of a second memory card;
receiving, from the second memory card, second image information taken by the imaging terminal and second image identification information for identifying the second image information from the second memory card; and
correlating and storing the fourth memory card identification information with the second image information and the second image identification information.

6. The information terminal according to claim 4 further configured to execute steps of:
correlating and storing first appearance information representing an appearance of the first memory card with the second memory card identification information; and
correlating and storing second appearance information representing an appearance of the second memory card with the fourth memory card identification information.

7. The information terminal according to claim 4 further configured to execute steps of:
sending the second memory card identification information and the fourth memory card identification information to a first server in which first appearance information representing an appearance of the first memory card with the second memory card identification information are correlated and stored, and in which second appearance information representing and appearance of the second memory card and the fourth memory card identification information are correlated and stored;
receiving the first appearance information and the second appearance information from the first server;
correlating the first image information and the first appearance information and displaying on the image information display part; and
correlating the second image information and the second appearance information and displaying on the image information display part.

8. The information terminal according to claim 4 further configured to execute steps of:
generating a first summary image having a smaller amount of information than the first image information;
generating a second summary image having a smaller amount of information than the second image information;
sending the first summary image to the second server for correlating and storing the second image identification information and the first appearance information; and
sending the second summary image to the second server for correlating and storing the fourth image identification information and the second appearance information.

9. The information terminal according to claim 6 further configured to execute steps of:
generating a first summary image having a smaller amount of information than the first image information;
generating a second summary image having a smaller amount of information than the second image information;
displaying the first summary image and the second summary image as an all image selection screen on the image information display part;
deleting the second summary image from the all image selection screen when the first appearance information displayed on the image information display part is selected; and
deleting the first summary image from the all image selection screen when the second appearance information displayed on the image information display part is selected.

10. A system configured to execute steps of:
storing first memory card identification information into a first memory card identification information storage part of a first memory card;
sending from the first memory cared to an imaging terminal the first memory card identification information which cannot be read by an information terminal;
generating second memory card identification information as a result of performing a calculation on the first memory card identification information at the imaging terminal;
sending from the imaging terminal to the first memory card the second memory card identification information;
storing from the imaging terminal to the first memory card the second memory card identification information into a second identification information storage part in the first memory card;
sending first image information taken by the imaging terminal, first summary image information generated from the first image information, and first image identification information for identifying the first image information;
correlating and storing the first image information, the first summary image information and the first image identification information into the first memory card;
storing third memory card identification information into a third memory card identification information storage part of a second memory card;
sending from the information terminal to the imaging terminal the third memory card identification information which cannot be read by the information terminal;
generating fourth memory card identification information as a result of performing a calculation on the third memory card identification information at the imaging terminal;
sending from the imaging terminal to the second memory card the fourth identification information;
storing the fourth identification information into a fourth identification information storage part by the second memory card;
sending from the imaging terminal to the second memory card second image information taken by the imaging terminal, second summary image information generated from the second image information, and second image identification information for identifying the second image information;
correlating and storing the second image information, the second summary image information, and the second image identification information into the second memory card;
sending from the first memory card the second memory card identification information, the first image information, the first summary image information, and the first image identification information, the second memory card identification information, the first image information, the first summary image information, and the first image identification information being correlated;
correlating and storing the second memory card identification information, the first image information, the first summary image information, and the first image identification information into the information terminal;
sending from the second memory card the fourth memory card identification information, the second image information, the second summary image information, and the second image identification information, the fourth memory card identification information, the second image information, the second summary image information, and the second image identification information being correlated; and
correlating and storing the fourth memory card identification information, the second image information, the second summary image information, and the second image identification information into the information terminal.

11. The system according to claim 10 further configured to execute steps of:
displaying by a first display means of the information terminal the second memory card identification information and the first summary image information, and displaying by the first display means of the information terminal the fourth memory card identification information and the second summary image information, in a stated where the second memory card identification information and the first summary image information are correlated and in a state where the fourth memory card identification information and the second summary image information are correlated.

12. The system according to claim 10 further configured to execute steps of:
sending from the information terminal to a server the second memory card identification information and the first summary image information, in a state where the second memory card identification information and the first summary image information are correlated; and
sending from the information terminal to the server the fourth memory card identification information, the second image identification information and the second summary image information, in a state where the fourth memory card identification information, the second image identification information and the second summary image information are correlated.

13. The system according to claim 12 further configured to executed steps of:
displaying by a second display means of a mobile terminal the second memory card identification information stored in the server and the first summary image information stored in the server, in a state where the second memory card identification information and the first summary image information are correlated; and
displaying by the second display means of the mobile terminal the fourth memory card identification information stored in the server and the second summary image information stored in the server in a state where the fourth memory card identification information and the second summary image information are correlated.

14. A system configured to execute steps of:
sending, from a memory card to a first imaging terminal, first memory card identification information in a first memory card identification information storage part, the first memory card identification information being unable to be read from an information terminal;
generating second memory card identification information which is a result of performing a calculation on the first memory card identification information at the first imaging terminal;
sending from the first imaging terminal to the memory card the second memory card identification information;
storing the second memory card identification information into a second identification information storage part into the memory card;
sending from the first imaging terminal to the memory card first image information taken by the first imaging terminal, first summary image information generated from the first image information, and first image identification information for identifying the first image information;
correlating and storing the first image information, the first summary image information, and the first image identification information into the memory card;
sending the first memory card identification information to a second imaging terminal;
generating third memory card identification information which is a result of performing a calculation on the first memory card identification information at the second imaging terminal;
sending from the second imaging terminal to the memory card the third memory card identification information;
storing the third memory card identification information into the second memory card identification information storage part of the memory card;
sending from the second imaging terminal to the memory card second image information taken by the second imaging terminal, second summary image information generated from the second image information, and second image identification information for identifying the second image information;
correlating and storing the second image information, the second summary image information, and the second image identification information into the memory card;
sending from the memory card to the information terminal the first summary image information, the first image identification information, and the second memory card identification information, the first summary image information, the first image identification information, and the second memory card identification information being correlated;
sending from the memory card to the information terminal the second summary image information, the second image identification information, and the third memory card identification information, the second summary image information, the second image identification information, and the third memory card identification information being correlated; and
correlating and storing the first summary image information, the first image identification information, and the second memory card identification information, and correlating the second summary image information, the second image identification information and the third memory card identification information respectively into the information terminal.

15. The information terminal according to claim 5 further configured to execute steps of:
correlating and storing first appearance information representing an appearance of the first memory card with the second memory card identification information; and
correlating and storing second appearance information representing an appearance of the second memory card with the fourth memory card identification information.

16. The information terminal according to claim 5 further configured to execute steps of:
sending the second memory card identification information and the fourth memory card identification information to a first server in which first appearance information representing an appearance of the first memory card with the second memory card identification information are correlated and stored, and in which second appearance information representing and appearance of the second memory card and the fourth memory card identification information are correlated and stored;
receiving the first appearance information and the second appearance information from the first server;
correlating the first image information and the first appearance information and displaying on the image information display part; and
correlating the second image information and the second appearance information and displaying on the image information display part.

17. The information terminal according to claim 5 further configured to execute steps of:
generating a first summary image having a smaller amount of information than the first image information;
generating a second summary image having a smaller amount of information than the second image information;
sending the first summary image to the second server for correlating and storing the second image identification information and the first appearance information; and
sending the second summary image to the second server for correlating and storing the fourth image identification information and the second appearance information.

18. The information terminal according to claim 6 further configured to execute steps of:
generating a first summary image having a smaller amount of information than the first image information;
generating a second summary image having a smaller amount of information than the second image information;
sending the first summary image to the second server for correlating and storing the second image identification information and the first appearance information; and
sending the second summary image to the second server for correlating and storing the fourth image identification information and the second appearance information.

19. The information terminal according to claim 7 further configured to execute steps of:
generating a first summary image having a smaller amount of information than the first image information;
generating a second summary image having a smaller amount of information than the second image information;
sending the first summary image to the second server for correlating and storing the second image identification information and the first appearance information; and
sending the second summary image to the second server for correlating and storing the fourth image identification information and the second appearance information.

20. The information terminal according to claim 7 further configured to execute steps of:
generating a first summary image having a smaller amount of information than the first image information;
generating a second summary image having a smaller amount of information than the second image information;
displaying the first summary image and the second summary image as an all image selection screen on the image information display part;
deleting the second summary image from the all image selection screen when the first appearance information displayed on the image information display part is selected; and
deleting the first summary image from the all image selection screen when the second appearance information displayed on the image information display part is selected.
